(19) United States
(12) Patent Application Publication
(10) Pub. No.: US 2026/0357158 A1
(43) Pub. Date: Nov. 12, 2026

(54) AQUEOUS POLYMER DISPERSIONS SUITABLE AS OPACIFIERS IN LIQUID FORMULATIONS, PROCESS TO PRODUCE, AND THEIR USE

(71) Applicant: BASF SE, Ludwigshafen am Rhein (DE)

(72) Inventors: Thomas WEISS, Ludwigshafen am Rhein (DE); Roland ETTL, Ludwigshafen am Rhein (DE); Aaron WAGNER, Ludwigshafen am Rhein (DE); Volker KREIDER, Worms (DE)

(21) Appl. No.: 19/128,590

(22) PCT Filed: Nov. 14, 2023
(86) PCT No.: PCT/EP2023/081697

§ 371 Date: May 9, 2025

(30) Foreign Application Priority Data
Nov. 23, 2022 (EP) 22208973.2
Nov. 23, 2022 (EP) 22208974.0

(51) Int. Cl. C11D 3/37; C11D 3/22; C11D 3/34; C11D 3/39; C11D 17/00

(52) U.S. Cl. CPC C11D 3/3788; C11D 3/225; C11D 3/3463; C11D 3/3945; C11D 17/0017

(57) ABSTRACT

Described herein are aqueous polymer dispersions, which are suitable as opacifiers in liquid formulations, a process to produce the aqueous polymer dispersions, the use of the aqueous polymer dispersions within cleaning compositions and the cleaning compositions.

The aqueous polymer dispersions are obtainable by radical emulsion polymerization in an aqueous environment by polymerizing i) at least one vinyl ester, ii) at least one (meth)acrylic acid ester, and iii) optionally further polymerizable monomers, in the presence of a) a carboxyl-groups-containing compound bearing in its structure at least three carboxyl-groups of which at least 10 and at most 90 percent are deprotonated, b) at least one carboxylated or non-carboxylated saccharide and/or carboxylated or non-carboxylated polysaccharide, and c) at least one emulsifier selected from non-ionic and anionic surfactants, the resulting aqueous polymer dispersion optionally containing sulfate ions and/or sulfite ions.

The present invention relates to aqueous polymer dispersions, which are suitable as opacifiers in liquid formulations.

The invention further relates to aqueous polymer dispersions obtainable by radical emulsion polymerization in aqueous environment by polymerizing i) at least one vinyl ester, ii) least one (meth)acrylic acid ester, which may optionally comprise methacrylic acid as minor component, the (meth)acrylic acid in the methacrylic acid ester being bonded via an ether-function to a polyalkylene oxide-derived-block (PAO), wherein the PAO consists of 2 to 40 alkylene oxide (AO), iii) optionally further polymerizable monomers, in the presence of a) a carboxyl-groups-containing compound being selected from a compound bearing in its structure at least three carboxyl-groups of which at least 10 and at most 90 percent are being deprotonated, b) at least one carboxylated or non-carboxylated saccharide and/or carboxylated or non-carboxylated polysaccharide, and c) at least one emulsifier selected from non-ionic and anionic surfactants, the resulting aqueous polymer dispersion optionally containing also sulfate ions and/or sulfite ions. The use of such aqueous polymer dispersions within cleaning compositions such as detergents is also encompassed, including the use of the aqueous polymer dispersions as opacifiers.

The invention also relates to formulations and compositions within the field of application of fabric and home care, industrial and institutional cleaning, comprising at least one aqueous polymer dispersion as disclosed herein.

Due to the climate change, one of the most important targets of the detergent and cleaning (D&C) industry today is to significantly lower the CO2 emission per wash, by improving e.g. cold water conditions by improving the cleaning efficiency at low temperatures of below 40, 30 or 20 or even colder, to lower the amounts of chemicals employed per wash, increasing the weight-efficiency of the cleaning technologies, reducing the amount of water per wash, introducing bio-derived com-ponents etc. Hence, one important target of the D&C industry is the need to improve the sustain-ability of the cleaning formulations by improving efficiency, especially also at lower temperatures, needing less water (especially also in the laundry and dish wash formulations) and to avoid the accumulation of non-degradable compounds in the ecosystem. Such reduction in CO2-emision or the desire to improve the “footprint” of any product is of high and even further rising interest in the industry and with the consumers, be it in terms of its origin like being from natural or renewable resources, or—all compared to previous products—its production in terms of production efficiency and thus reduced usage of energy, its efficiency in usage such as reduced amounts for the same performance or higher performance at the same amount levels used, its persistence in the natural environment upon and/or after its usage such as bio-degradation.

As a result of these trends, there is a strong need for new biodegradable cleaning additives that provide at least comparable cleaning properties and a reduction in the CO2-footprint by being bioderived, bio-degradable or even both. The materials should preferably exhibit good primary clean-ing activity, soil removal for oily/fatty and particulate stains and/or should lead to improved white-ness maintenance, thus minimizing also the amount of suspended and emulsified oily/fatty and particulate soil from redepositing on the surfaces of the textiles or hard surfaces, etc.

Hence, one need resides in the provision of compounds being bio-degradable and still having at least the same performance as already known but not bio-degradable compounds, such biodegradation as measured under de-fined conditions within 28 days as to be required by many users especially in the field of detergents, and as being a future requirement by applicable legislation in several countries and regions of the world.

### PRIOR ART

State-of-the-art opacifiers are based on styrene/methacrylic acid copolymers, produced by emulsion polymerization. They are widely used in Home Care & Personal Care products. A drawback is the lack of biodegradability. Further, the current production process suffers from reactor fouling and high amounts of coagulum which reduces the overall capacity in commercial plants.

D1 (EP1924633, BASF) claims a process and the dispersion consisting of vinyl acetate and 0.05-5.0% by weight of methacrylic acid, which is obtained by free-radically initiated emulsion polymerization. The particle size was determined to be 100-200 nm. A protective colloid (Kollidon 30, polyvinylpyrrolidone K30) was used and sodium dodecyl sulfate was used as the emulsifier. Target applications are film coatings in pharmacological and cosmetic applications, delayed release of active ingredients. Biodegradation results were not published. The use of polycarboxylates such as carboxymethyl cellulose to improve biodegradation has not been disclosed.

D2 (DE102004031970, Wacker) describes a process and solution polymerization in methanol consisting of vinyl monomers such as vinyl acetate and ethylenically unsaturated polyethers such as allyl polyethers. Also claimed are the esters of polyethers corresponding to methacrylic acid with the end groups OH and OR, where R can be alkyl with C1-C40. Target application for the production of plasticized vinyl acetate solid resins. Biodegradation results were not published. The use of polycarboxylates such as carboxymethyl cellulose to improve biodegradation has not been disclosed.

In D3 (JP2005089540, Konishi), an emulsion process is used to produce a vinyl acetate polymer resin in the presence of polymerizable polyethylene glycol derivatives. The use of cellulose-based protective colloids is reported. Target application for making adhesive, film forming, fiber and paper coatings and binders in paper processing. Biodegradation results were not published. The use of polycarboxylates such as carboxymethyl cellulose to improve biodegradation has not been disclosed.

In D4 (JP06093007, Aica Kogyo, JP1992-269400), a polyvinyl acetate-based emulsion is reported by subjecting 50-100% by weight of vinyl acetate and 0-50% by weight of one or more comonomers (e.g. acrylic acid ester) to an emulsion polymerisation using a water-soluble modified starch (e.g. esterified starch or etherified starch) of 10-200% by weight, based on the total monomers, as a protective colloid. Target application for producing films with good low temperature properties, high hardness. Biodegradation results were not published. The use of polycarboxylates such as carboxymethyl cellulose to improve biodegradation has not been disclosed.

D5 (U.S. Pat. No. 4,708,999, Celanese, Air Products& Chemicals, US1986-894419) describes a solution polymerization with vinyl acetate and C1 to C12 alkyl polyethylene glycol methacrylic acid ester (polyethylene glycol with 25 ethylene oxide) in methanol. The product is then subjected to methanolysis. The amount of methacrylic acid ester is given in examples from 0.56 to 1.85 mol %, claim 1 includes 0.001-50 mol %. The molecular weights in the examples are given as between 36,000 and 77,000 g/mol. Biodegradation results were not published. The use of polycarboxylates such as carboxymethyl cellulose to improve biodegradation has not been disclosed.

In D6 (JP59155411, NIPPON SYNTHETIC CHEM., JP1983-028686), a copolymer of an oxyalkylene group-containing unsaturated monomer with vinyl acetate in a solution polymerization in alcohol is described. The copolymerization of vinyl acetate comprises an oxyalkylene group-containing unsaturated monomer (such as methacrylic acid) . . . . The number of oxyalkylene groups, i.e. n, from advantageously 1-50 and preferably about 3-50. The end of the oxoalkylene group may be alkyl. The examples preferably include allyl polyoxoethylene, an example being (10EO)-oxoethylene methacrylate. Application of the modified vinyl acetate resin which is water-soluble even in the absence of alkali metal and is suitable for use in paste, adhesive or aqueous solution in paper processing or the like. Biodegradation results were not published. The use of polycarboxylates such as carboxymethyl cellulose to improve biodegradation has not been disclosed.

D7 (U.S. Pat. No. 3,322,703, Cumberland Chemical) claims a copolymer consisting of vinyl acetate and an alkoxy polyalkylene glycol half ester of unsaturated dicarboxylic acids or/and vinyl acetate and an alkoxy polyalkylene glycol ester of unsaturated monocarboxylic acids and the method of preparation. Solution polymerization in methanol of vinyl acetate and methyoxpolyethylene glycol maleate was given as an example. A use is not claimed but described in the form of applications of gummed articles that can be moistened and form sticky films, for example for postage stamps. Biodegradation results were not published. The use of polycarboxylates such as carboxymethyl cellulose to improve biodegradation has not been disclosed.

A terpolymer consisting of vinyl alcohol, vinyl acetate and alkylpolyoxoethylene methacrylic acid ester is claimed in D8 (EP199358 by Celanese Corp). The fabric protection includes at least 50% vinyl alcohol in the terpolymer. The use of the terpolymer as a barrier layer in thermoplastic processes for packaging articles. Biodegradation results have not been published. The use of polycarboxylates such as carboxymethyl cellulose to improve biodegradation has not been disclosed.

### OBJECTIVE

Due to the climate change, one of the most important targets of the detergent and cleaning (D&C) industry today is to significantly lower the CO2 emission per wash, by improving e.g. cold water conditions by improving the cleaning efficiency at low temperatures of below 40, 30 or 20 or even colder, to lower the amounts of chemicals employed per wash, increasing the weight-efficiency of the cleaning technologies, introducing bio-derived components etc. Hence, one important target of the D&C industry is the need for biodegradable ingredients, to improve the sustainability of the cleaning formulations (and especially the laundry and dish wash formula-tions) and to avoid the accumulation of non-degradable compounds in the ecosystem. Hence, there is a need to provide compounds being bio-degradable and still having at least the same performance as already known but not biodegradable compounds, such biodegradation as measured under defined conditions within 28 days as to be required by many users especially in the field of detergents, and as being a future requirement by applicable legislation in several countries and regions of the world.

Such reduction in CO2-emision or the desire to improve the “footprint” of any product is of high and even further rising interest in the industry and with the consumers, be it in terms of its origin like being from natural or renewable resources, or—all compared to previous products—its pro-duction in terms of production efficiency and thus reduced usage of energy, its efficiency in us-age such as reduced amounts for the same performance or higher performance at the same amount levels used, its persistence in the natural environment upon and/or after its usage such as bio-degradation.

As a result of these trends, there is a strong need for new biodegradable cleaning additives that provide at least comparable cleaning properties and a reduction in the CO2-footprint by being bioderived, bio-degradable or even both. The materials should preferably exhibit good primary cleaning activity, soil removal for oily/fatty and particulate stains and/or should lead to improved whiteness maintenance, minimizing the amount of suspended and emulsified oily/fatty and par-ticulate soil from redepositing on the surfaces of the textiles or hard surfaces, etc.

Hence, it was the objective to provide an opacifier for compositions, such as detergent, cleaning and/or fabric and home care compositions/formulations, having an improved biodegradation.

The objective was solved by the aqueous dispersion as defined herein, the process to produce such dispersion, and its use and including compositions comprising such dispersion.

The aqueous dispersion of this invention, obtainable or obtained by a process according to the present invention may be used in specific compositions, such as detergent, cleaning and/or fabric and home care compositions/formulations, as opacifier.

### DEFINITIONS

All terms have their ordinary meaning unless specifically defined otherwise within this disclosure either in the following or throughout the description.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein the term “comprising” can be substituted with the term “containing” or “including” or sometimes when used herein with the term “having”.

When used herein, “consisting of” excludes any element, step, or ingredient not specified in the claim element. When used herein, “consisting essentially of” does not exclude materials or steps that do not materially affect the basic and novel characteristics of the claim.

In each instance herein any of the terms “comprising”, “consisting essentially of” and “consisting of” may be replaced with either of the other two terms. “Comprising” may be replaced in a preferred embodiment with “consisting essentially of” and both may be replaced by “consisting of” in an even more preferred embodiment.

The compositions of the present disclosure can “comprise” (i.e. contain other ingredients), “consist essentially of” (comprise mainly or almost only the mentioned ingredients and other ingredients in only very minor amounts, mainly only as impurities), or “consist of” (i.e. contain only the mentioned ingredients and in addition may contain only impurities not avoidable in an technical environment, preferably only the ingredients) the components of the present disclosure.

Similarly, the terms “substantially free of . . . ” or” substantially free from . . . ” or “(containing/comprising) essentially no . . . ” may be used herein; this means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or even less than 0.1%, or even more less than 0.01%, or even 0%, by weight of the composition.

Generally, as used herein, the term “obtainable by” means that corresponding products do not necessarily have to be produced (i.e. obtained) by the corresponding method or process de-scribed in the respective specific context, but also products are comprised which exhibit all features of a product produced (obtained) by said corresponding method or process, wherein said products were actually not produced (obtained) by such method or process. However, the term “obtainable by” also comprises the more limiting term “obtained by”, i.e. products which were actually produced (obtained) by a method or process described in the respective specific context.

When used herein any definition requiring a compound or a substituent of a compound to consist of “at least a number of carbon atoms”, number of carbon atoms refers to the total number of carbon atoms in said compound or substituent of a compound. For example for a substituent disclosed as “alkyl ether with at least 8 carbon atoms comprising alkylene oxide groups”, the total number of at least 8 carbon atoms needs to be the sum of the number of carbon atoms of the alkyl moiety and the number of carbon atoms of the alkylene oxide moieties.

All such terms not specifically defined have their ordinary meaning as known in the field of organic chemistry.

As used herein, the articles “a” and “an” when used in a claim or an embodiment, are understood to mean one or more of what is claimed or described. As used herein, the terms “include(s)” and “including” are meant to be non-limiting, and thus encompass more than the specific item mentioned after those words.

The term “about” as used herein encompasses the exact number “X” mentioned as e.g. “about X %” etc., and small variations of X, including from minus 5 to plus 5% deviation from X (with X for this calculation set to 100%), preferably from minus 2 to plus 2%, more preferably from minus 1 to plus 1%, even more preferably from minus 0.5 to plus 0.5% and smaller variations. Of course if the value X given itself is already “100%” (such as for purity etc.) then the term “about” clearly can and thus does only mean deviations thereof which are smaller than “100”.

The term “free of water” means that the composition contains no more than 5 wt.-% of water based on the total amount of solvent, in another embodiment no more than 1 wt.-% of water based on the total amount of solvent, in a further embodiment the solvent contains no water at all.

All temperatures herein are in degrees Celsius (°C) unless otherwise indicated. Unless otherwise specified, all measurements herein are conducted at 20 °C and under the atmospheric pressure. In all embodiments of the present disclosure, all percentages are by weight of the total composition, unless specifically stated otherwise. All ratios are weight ratios, unless specifically stated otherwise.

The phrase “fabric care composition” is meant to include compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein and detailed herein below when describing the compositions. Such compositions may be used as a pre-laundering treatment, a post-laundering treatment, or may be added during the rinse or wash cycle of the laundering operation, and as further detailed herein below when describing the use and application of the inventive and compositions comprising such inventive dispersion.

Molecular weight descriptors Mw, Mn and polydispersity (PDI as polydispersity index) of the molecular weight; pH-value.

All percentages given are weight percentages based on the total weight of that composition, dispersion, feed, mixture etc., unless specifically defined otherwise; abbreviated as “wt %”.

“Bio-degradable”, “biodegradation” with or without the addition of “as tested under standard conditions” mean the biodegradation and—if percentages are given such as “30% bio-degradation/biodegradable” of the mentioned substance, compound or formulation, which has been determined using biodegradability tests according to OECD301F (as used in the example section).

“Medium particle size” and the corresponding “medium particle size measurement” means the particle size D[4,3] as measured using a Malvern Mastersizer 2000 in aqueous environment using standard methods and ingredients. The Mastersizer used for the present invention was equipped with a Hydro 2000S (a) as accessory, using water as dispersant, at a concentration of 0.0220 volume percent.

“Transmittance of 532 nm-wavelength-light” means the transmittance measured with a wave length of 532 nm light using standard machines, such as preferably Hach Lange DR6000 spectrometer, compared to the transmittance of the standard, which usually is plain water suitable for such measurement, preferably being distilled or even bi-distilled water, at a concentration of 0.01 wt. % and a cuvette of 1 centimeter length of dispersion for the rays to pass through.

The pH-measurement is done as described in the experimental section.

Throughout this description, the term “inventive compound” may be used instead of the “inventive (aqueous) dispersion” and “(aqueous) dispersion of this (present) invention”, meaning those compound(s) being disclosed herein as invention, defined by their structure and/or their process to produce and/or obtainable by the process defined herein.

### DETAILED DESCRIPTION OF THE INVENTION

The definitions and their preferences given within the “Definition”-section before are included as part of this invention as described herein below.

The specific embodiments as described throughout this disclosure are encompassed by the present invention as part of this invention; the various further options being disclosed in this present specification as “optional”, “preferred”, “more preferred”, “even more preferred” or “most preferred” (or “preferably” etc.) options of a specific embodiment may be individually and independently (unless such independent selection is not possible by virtue of the nature of that feature or if such independent selection is explicitly excluded) selected and then combined within any of the other embodiments (where other such options and preferences can be also selected individually and independently unless such independent selection is not possible by virtue of the nature of that feature or if such independent selection is explicitly excluded), with each and any and all such possible combinations being included as part of this invention as individual embodiments.

Specifically, this invention relates to an aqueous polymer dispersion, obtainable by radical aqueous emulsion polymerization of a mixture comprising
a) ethylenically unsaturated monomers M, with M comprising
   (1) (M1) at least one vinyl ester, preferably comprising vinyl acetate, more preferably comprising vinyl acetate at least 50%, even more preferably at least 90%, and
   (2) (M2) at least one (meth)acrylic acid ester optionally comprising meth-acrylic acid as minor component, the (meth)acrylic acid in the meth-acrylic acid ester being bonded via an ether-function to a polyalkylene oxide-derived-block (PAO), wherein the PAO consists of 2 to 40 alkylene oxide (AO), most preferably 25 AO-units, with the PAO prefera-bly being further linked via an ether-function to an C1 to C24, preferably at least C4, more preferably at least C6, even more preferably C8 to C24-aliphatic alkanol, most preferably a C18-aliphatic alkanol, with the AO being preferably selected from EO, PO and/or BuO, more preferably at least EO in an amount of from 50, more preferably at least 75, even more preferably at least 90 wt. % most preferably essentially only EO, based on total AO; preferably comprising methacrylic acid, more prefer-ably with the methacrylic acid ester and the free methacrylic acid being in a ratio of from about 70 w %/30 w % to 80 w %/20 w %, mor preferably about 75 w %/25 w %;
   (3) (M3) optionally further monomers polymerizable with M1 and M2, preferably none;
b) (CGCC) 1 to 15, preferably 2 to 10, more preferably 3 to 8, most preferably 4 to 6% by weight, based on the total weight of monomers M, of a carboxyl-groups-containing compound being selected from a compound bearing in its structure at least three, more preferably at least 6, 8, 10, 15, 20, 25 or more carboxyl-groups of which at least 10 and at most 90 percent are being deprotonated (thus forming salts with counter-ions; the counter-ions being selected from Na, K, NH4, Mg, Ca), selected from the group comprising citric acid, isocitric acid; eth-ylendiamintetraacetic acid; nitriloacetic acid; tartaric acid; oligomeric and poly-acrylic acid; oligomeric and poly methacrylic acid; trimelitic acid; oligomeric aminoacids with carboxy groups such as polyaspartic acid; oligomeric and poly-glutaminic acid; oligomeric and polyacetates with carboxygroups such as poly(glyoxalic)aldehyde; carboxylated oligomeric and polymeric saccharides such as oxidized starch (mixtures of amylopektines, amylose); polyglucu-ronates; cellulose oxidized to cellouronate; natural polycarboxylatic polysaccha-ride such as xylanes; pektines acid; alginic acid; carboxymethylated polysac-charides based on 1,4-polyglucanes, 1,3-polyglucanes, 1,6-polyglucanes; Poly-uronic acids based on 1,4-polyglucanes, 1,3-polyglucanes, 1,6-polyglucanes; polygalacturonic; preferably carboxylated polysaccharides, more preferably carboxylated cellulose, even more preferably carboxylated methylcellulose (carboxymethylcellulose, “CMC”); and
c) (S) at least one (non-carboxylated) sacharide and/or polysaccharide, such as glucose, starch degradation products, maltodextrin, in an amount of 2 to 50, preferably 5 to 35, more preferably 10 to 30, most preferably 15 to 25 wt % based on the total weight of monomers M,
And
d) at least one emulsifier selected from non-ionic and anionic surfactants, with
   i) the at least one an-ionic surfactant being selected from:
      anionic emulsifier bearing at least one anionic group, which is selected from phosphate, phosphonate, sulfate and sulfonate groups;
      the anionic emulsifier typically employed in the form of their alkali metal salts, especially of their sodium salts or in the form of their ammonium salts;
      preferably the anionic emulsifier bearing at least one sulfate or sulfonate group or at least one phosphate or phosphonate group, more preferably bearing at least one sulfonate or sulfate group, most preferably only one sulfonate or one sulfate group,
      i)a) with the anionic emulsifier bearing at least one sulfate or sulfonate group preferably being selected from
         the salts, especially the alkali metal and ammonium salts, of alkyl sul-fates, especially of C8-C22-alkyl sulfates,
         the salts, especially the alkali metal and ammonium salts, of sulfuric monoesters of C2-C3-alkoxylated alkanols, especially of sulfuric monoes-ters of C2-C3-alkoxylated C8-C22-alkanols, preferably having an C2-C3-alkoxylation level (AO level) in the range from 2 to 40,
         the salts, especially the alkali metal and ammonium salts, of sulfuric monoesters of C2-C3-alkoxylated alkylphenols, especially of sulfuric mo-noesters of C2-C3-alkoxylated C4 C18-alkylphenols (AO level preferably 3 to 40),
         the salts, especially the alkali metal and ammonium salts, of alkyl-sulfonic acids, especially of C8-C22-alkylsulfonic acids,
         the salts, especially the alkali metal and ammonium salts, of dialkyl esters, especially di-C4-C18-alkyl esters of sulfosuccinic acid,
         the salts, especially the alkali metal and ammonium salts, of alkylben-zenesulfonic acids, especially of C4-C22-alkylbenzenesulfonic acids, and
         the salts, especially the alkali metal and ammonium salts, of mono- or disulfonated, alkyl-substituted diphenyl ethers, for example of bis(phenylsulfonic acid) ethers bearing a C4-C24-alkyl group on one or both aromatic rings;
      With the term “C2-C3-alkoxylated” meaning that the compounds are ethoxylated, propoxylated or co-ethoxylated/propoxylated, i.e. meaning that the respective compounds are obtained by a process which introduces a poly-ethylenoxide group, a polypropyleneoxide group or a poly(ethyleneoxide-co-propyleneoxide) group;
      i)b) With the anionic emulsifier bearing at least one phosphate or phosphonate group, preferably being selected from
         the salts, especially the alkali metal and ammonium salts, of mono- and dialkyl phosphates, especially C8-C22-alkyl phosphates,
         the salts, especially the alkali metal and ammonium salts, of phos-phoric monoesters of C2-C3-alkoxylated alkanols, preferably having an alkoxylation level in the range from 2 to 40, especially in the range from 3 to 30, for example phosphoric monoesters of ethoxylated C8-C22-alkanols, preferably having an ethoxylation level (EO level) in the range from 2 to 40, phosphoric monoesters of propoxylated C8-C22-alkanols, preferably having a propoxylation level (PO level) in the range from 2 to 40, and phosphoric monoesters of ethoxylated-copropoxylated C8-C22-alkanols, preferably having an ethoxylation level (EO level) in the range from 1 to 20 and a propoxylation level of 1 to 20,
         the salts, especially the alkali metal and ammonium salts, of phos-phoric monoesters of C2-C3-alkoxylated alkylphenols, especially phosphoric monoesters of C2-C3-alkoxylated C4-C18-alkylphenols (AO level preferably 3 to 40),
         the salts, especially the alkali metal and ammonium salts, of al-kylphosphonic acids, especially C8-C22-alkylphosphonic acids and
         the salts, especially the alkali metal and ammonium salts, of alkylben-zenephosphonic acids, especially C4-C22-alkylbenzenephosphonic acids;
      With the more preferred anionic emulsifiers being selected from the following groups:
         the salts, especially the alkali metal and ammonium salts, of alkyl sul-fates, especially of C8-C22-alkyl sulfates,
         the salts, especially the alkali metal salts, of sulfuric monoesters of C2-C3-alkoxylated alkanols, especially of sulfuric monoesters of C2-C3-alkoxylated C8-C22-alkanols, preferably having an AO level in the range from 2 to 40,
         of sulfuric monoesters of C2-C3-alkoxylated alkylphenols, especially of sulfuric monoesters of C2-C3-alkoxylated C4-C18-alkylphenols (AO level preferably 3 to 40),
         of alkylbenzenesulfonic acids, especially of C4-C22-alkylbenzenesulfonic acids, and
         of mono- or disulfonated, alkyl-substituted diphenyl ethers, for exam-ple of bis(phenylsulfonic acid) ethers bearing a C4-C24-alkyl group on one or both aromatic rings;
   ii) the at least one non-ionic surfactant being selected from:
      nonionic emulsifiers are e.g. ar-aliphatic or aliphatic nonionic emulsifiers, selected from
         C2-C3-alkoxylated mono-, di- and trialkylphenols, with the number of repeating units of the alkylene oxide-derived moiety being preferably 3 to 50, and/or the alkyl radical being preferably C4-C10-alkyl;
         C2-C3-alkyoxlates, such as ethoxylates, propoxylates or ethoxylate-co-propoxylates, of long-chain alcohols with the number of repeating units of the al-kylene oxide-derived moiety being preferably 3 to 100, and/or the alkyl radical being preferably C8-C36-alkyl, and
         polyethylene oxide/polypropylene oxide homo- and copolymers, which may comprise the alkylene oxide units copolymerized in random distribution or in the form of blocks or mixtures of homo-blocks and random-blocks,
         more preferably C2-C3-alkoxylated of long-chain alkanols, in particular to those where the alkyl radical C8 C30 having a mean alkoxylation level of 5 to 100 and, among these, particular preference to those having a linear C12-C20 alkyl radical and a mean alkoxylation level of 10 to 50, and also to C2-C3-alkoxylated monoalkylphenols;
         and
e) optionally sulfate ions, and
f) optionally sulfite ions,
wherein—preferably—the amount of M1 is from 80 to 99.99 mol %, more preferably the amount of M1 being at least 98%, and the amount of M2 is from 0.01 to 20 mole %, more preferably from 0.1, even more preferably from 0.2, even more preferably from 0.5, and most preferably from 0.7, and preferably at most 10, even more preferably at most 5, more preferably at most 2%, and most preferably the amount of M1 being about 99 weight percent and the amount of M2 being about 1 weight percent, the total amount of M1 plus M2 being 100 weight percent, and
wherein the dispersion has—after the end of the polymerization—a pH of up to 4, more preferably below 4, even mor preferably at most 3.8, even more preferably at most 3.6, and more preferably at least 2.5, even more preferably at least 3, even more preferably at least 3.2, and most preferably at least 3.4.

In a preferred embodiment 2 of the aqueous polymer dispersion as defined before, (M1) the vinyl ester monomer comprises vinyl acetate with at least 50%, even more preferably at least 90% based on the total molar amount of vinyl esters.

In another preferred embodiment 3, (M2) the least one (meth)acrylic acid ester is a (meth)acrylic acid being bonded via an ether-function to a polyalkylene oxide-derived-block (PAO), wherein the PAO consists of 20 to 30 alkylene oxide (AO), most preferably 25 AO-units, with the PAO preferably being further linked via an ether-function to an C14 to C22-aliphatic alkanol, most preferably a C16/18-aliphatic alkanol, with the AO being selected from EO and PO and/or BuO, more preferably EO and PO, with the EO in an amount of from 75, even more preferably at least 90 wt. %, most preferably essentially only EO, based on total AO; further comprising methacrylic acid, with the methacrylic acid ester and the free methacrylic acid being in a ratio of from about 70 w %/30 w % to 80 w %/20 w %, more preferably about 75 w %/25 w %.

In a further preferred embodiment 4, (M3) is not comprised.

In an even more preferred embodiment 5, in the aqueous polymer dispersion as defined before,
(M1) the vinyl ester monomer comprises vinyl acetate with at least 50%, even more preferably at least 90% based on the total molar amount of vinyl esters,
(M2) the least one (meth)acrylic acid ester is a (meth)acrylic acid being bonded via an ether-function to a polyalkylene oxide-derived-block (PAO), wherein the PAO consists of 20 to 30 alkylene oxide (AO), most preferably 25 AO-units, with the PAO preferably being further linked via an ether-function to an C14 to C22-aliphatic alkanol, most preferably a C16/18-aliphatic alkanol, with the AO being selected from EO and PO and/or BuO, more preferably EO and PO, with the EO in an amount of from 75, even more preferably at least 90 wt. %, most preferably essentially only EO, based on total AO; further comprising methacrylic acid, with the methacrylic acid ester and the free methacrylic acid being in a ratio of from about 70 w %/30 w % to 80 w %/20 w %, mor preferably about 75 w %/25 w %, and (M3) is not comprised.

In a further more preferred embodiment 6, (M1) the vinyl ester monomer comprises vinyl acetate with at least 90% based on the total molar amount of vinyl esters, preferably essentially only vinyl acetate, and o(M2) the least one (meth)acrylic acid ester is a (meth)acrylic acid being bonded via an ether-function to a polyalkylene oxide-derived-block (PAO), wherein the PAO consists of 23 to 27 alkylene oxide (AO), most preferably on average 25 AO-units, with the PAO preferably being further linked via an ether-function to essentially C16/18-aliphatic alkanol, most preferably a C16/18-aliphatic alkanol, with the AO being essentially only EO; further comprising methacrylic acid, with the methacrylic acid ester and the free methacrylic acid being in a ratio of from about 70 w %/30 w % to 80 w %/20 w %, more preferably about 75 w %/25 w %, and (M3) is not present.

In a further more preferred embodiment 7 of the aqueous polymer dispersion as defined before, (M1) is vinyl acetate, and (M2) the least one (meth)acrylic acid ester is a methacrylic acid being bonded via an ether-function to a polyethylene oxide block (PEO), wherein the PEO consists of on average 25 AO-units, with the PEO being further linked via an ether-function to a C16/18-aliphatic alkanol, further comprising methacrylic acid, with the methacrylic acid ester and the free methacrylic acid being in a ratio of about 75 w %/25 w %, and (M3) is not present.

In a further more preferred embodiment 8, and preferably in combination with any of the embodiments before, the aqueous dispersion comprises as the (CGCC) a carboxyl-groups-containing compound being selected from carboxylated polysaccharides, more preferably carboxylated cellulose, even more preferably carboxylated methylcellulose (carboxymethylcellulose, “CMC”), preferably in amounts of from 1 weight % up to 15 weight percent, more preferably up to 10, even more preferably up to 5 wt % and most preferably about 5 weight percent based on the total amount of monomers (M1+M2+M3).

It is believed that the CGCC is able to interact with the polymerized moiety derived from the at least one monomer M2 within the polymer product which is dispersed within the dispersion. By such interaction an excellent compatibility and stability of the dispersion seems to result; also, such interactions favors the attack at the chemical structure and thus provides the high biodegradation percentage of the aqueous polymer dispersion observed, which is higher than dispersions not containing a carboxyl-groups-containing compound (CGCC).

In one further preferred embodiment 9, and preferably in combination with any of the embodiments before, the aqueous polymer dispersion comprises (S) at least one saccharide and/or polysaccharide which is a starch degradation product, preferably a maltodextrin, in an amount of 10 to 30, most preferably 15 to 25 wt % based on the total weight of monomers M.

In a preferred variation of this embodiment 9 before, (S) is a degraded starch having a dextrose equivalent according to Lane and Eynon in the range from 2 to 40%.

In a preferred variation of the two embodiments before, (S) is maltodextrin with a DE-value of from 10 to 30, preferably 12 to 16 or 25 to 30.

In a preferred variation of the two embodiments 8 and 9 before, (S) is a degraded starch having a number average molecular weight in the range from 300 to 2000 Dalton, as determined by osmometry, and preferably in a range of from 5 to 150, more preferably up to 70, even more preferably up to 50, and more prefer-ably from 10, even more preferably from 15, and most preferably from 20, each in weight percent based on the total weight of monomers M1+M2+M3.

Such degraded starches can be obtained by known means, such as chemical degradation, catalytic degradation with suitable catalysts or using enzymes. It is preferred herein, that (S) stems from an enzymatic degradation as this is a clean and fast approach with basically no chemical residues from the degradation reaction within the degradation products (besides starch and sugars from the starch).

The use of maltodextrine additionally provides an increased stability at lower temperature of storage for the inventive dispersions.

The aqueous polymer dispersions of this invention can be obtained with a D[4,3] value as determined by static light scattering of at least 400 and up to 1000 nm. Thus, such dispersions are suitable as opacifier in liquid formulations. The use as such opacifier is also claimed herein.

The aqueous polymer dispersions of this invention of any of the embodiments disclosed herein, have at least one of the following properties a) to d), preferably at least two, more preferably at least three, and most preferably all of the hereinafter defined properties:
a) a transmittance of 532 nm-wavelength-light of at least 20% when measured as a 0.01 wt %. dispersion in water,
b) a pH of in between 2.5 and 9, preferably from 3, more preferably from 3.3, and more preferably up to 7, even more preferably up to 6, even more preferably up to 5, and most preferably about 3.5;
c) a density of from 1.04 bis 1.08 g/mL measured as 10 wt. %-dispersion (based on solid content), and
d) a viscosity of from 30 to 1000 mPas (Brookfield viscosity, spindle 3; measured as 30 wt. % dispersion containing 30 wt. % active (active=polymer plus CGCC plus S); based on solid content; concentration as applicable by measurement).

Also part of this invention is a process suitable for large-scale production of aqueous polymer dispersions of this invention of any of the embodiments disclosed herein, such process comprising
(A) polymerizing ethylenically unsaturated monomers M, with M comprising
(M1) at least one vinyl ester, preferably comprising vinyl acetate, more preferably comprising vinyl acetate at least 50%, even more preferably at least 90%, and
(M2) at least one (meth)acrylic acid ester optionally comprising meth-acrylic acid as minor component, the (meth)acrylic acid in the meth-acrylic acid ester being bonded via an ether-function to a polyalkylene oxide-derived-block (PAO), wherein the PAO consists of 2 to 40 alkylene oxide (AO), most preferably 25 AO-units, with the PAO preferably being further linked via an ether-function to an C1 to C24, preferably at least C4, more preferably at least C6, even more preferably C8 to C24-aliphatic alkanol, most preferably a C18-aliphatic alkanol, with the AO being preferably selected from EO, PO and/or BuO, more preferably at least EO in an amount of from 50, more preferably at least 75, even more preferably at least 90 wt. % most preferably essentially only EO, based on total AO; preferably comprising methacrylic acid, more prefer-ably with the methacrylic acid ester and the free methacrylic acid being in a ratio of from about 70 w %/30 w % to 80 w %/20 w %, more preferably about 75 w %/25 w %; and
(M3) optionally further monomers polymerizable with M1 and M2, preferably none;
in the presence of
   at least one emulsifier,
   water,
   (CGCC) 1 to 15, preferably 2 to 10, more preferably 3 to 8, most preferably 4 to 6% by weight, based on the total weight of monomers M, of a carboxyl-groups-containing compound being selected from a compound bearing in its structure at least three, more preferably at least 6, 8, 10, 15, 20, 25 . . . , carboxyl-groups of which at least 10 and at most 90 percent are being deprotonated (thus forming salts with counter-ions; the counter-ions being selected from Na, K, NH4, Mg, Ca), selected from the group comprising citric acid, isocitric acid; ethylendiamintetraacetic acid; nitriloacetic acid; tartaric acid; oligomeric and poly-acrylic acid; oligomeric and poly methacrylic acid; trimelitic acid; oligomeric aminoacids with carboxy groups such as polyaspartic acid; oligomeric and poly-glutaminic acid; oligomeric and polyacetates with carboxygroups such as poly(glyoxalic)aldehyde; carboxylated oligomeric and polymeric saccharides such as oxidized starch (mixtures of amylopektines, amylose); polyglucu-ronates; cellulose oxidized to cellouronate; natural polycarboxylatic polysaccha-ride such as xylanes; pektines acid; alginic acid; carboxymethylated polysaccharides based on 1,4-polyglucanes, 1,3-polyglucanes, 1,6-polyglucanes; Poly-uronic acids based on 1,4-polyglucanes, 1,3-polyglucanes, 1,6-polyglucanes; polygalacturonic; preferably carboxylated polysaccharides, more preferably carboxylated cellulose, even more preferably carboxylated methylcellulose (carboxymethylcellulose, “CMC”); and
   (S) at least one (non-carboxylated) sacharide and/or polysaccharide, such as glucose, starch degradation products, maltodextrin, in an amount of 2 to 50, preferably 5 to 35, more preferably 10 to 30, most preferably 15 to 25 wt % based on the total weight of monomers M,
With the use of at least one radical initiator or a radical initiator couple, such couple preferably comprising a peroxide and a reducing compound;
such polymerization being performed
   in a reaction container equipped with either pressurized equipment and/or equipment to control boiling of the ingredients and with such measure(s) being able to contain the ingredients within the reaction container during the reaction at elevated temperature;
   at a temperature of from 60 to 90, preferably 70 to 80 °C;
   at a pH of up to 4, more preferably below 4, even more preferably at most 3.8, even more preferably at most 3.6;
With
B) optionally adding further radical initiator or initiator couple to further reduce the content of the unreacted monomers and/or to reduce the colour of the to be obtained polymer dispersion;
C) optionally adding at least one further reducing compound to reduce the colour of the to be obtained polymer dispersion,
D) optionally adding at least one further additive that might be needed or desired as additional ingredient within the to be obtained polymer dispersion;
E) optionally performing a step of removing evaporable compounds from the reaction mixture by employing a distillation step and/or a stripping step using steam or a gas, preferably steam;
F) optionally performing a step of filtrating the polymer dispersion from the previous step, preferably using a 125 micrometer filter;
to obtain the aqueous polymer dispersion.

As a result of the polymerization reaction, the aqueous dispersion may contain sulfite and/or sulfate ions. Those arise mainly from the use of persulfate-radical initiators.

During the polymerization, the pH-value of the mixture typically decreases due to the formation of acid from the use of the persulfate-initiators. In principle, this decrease of pH can be minimized by adding a base. However, the use of a base is not preferred. The amount of coagulates typically increases the more base is added as the amount of electrolytes increases.

In preferred embodiment P1 of the process as defined before, for the main polymerization step at least one persulfate as radical polymerization initiator and ascorbic acid and/or iso-ascorbic acid are employed.

In preferred embodiment P2 of the process as defined before, and preferably in combination with any of the embodiments before, the radical polymerization initiator additionally comprises a transition metal, preferably an iron-containing salt. In the most preferred embodiment P2a, no transition metal is employed. Iron-containing salt are typically complexes of iron-cations, such as complexes with EDTA and the like. Such complexes are known for such applications in combination with persulfate-radical initiators.

In preferred embodiment P3 of the process as defined before, and preferably in combination with any of the embodiments before, in the post polymerization step at least one hydroperoxide and at least one sulfite salt are employed.

In preferred embodiment P3 of the process as defined before, and preferably in combination with any of the embodiments before, at least 5% of the total amount of the hydroperoxide being added in the post polymerization step is added after the end of the addition of the sulfite.

In preferred embodiment P4 of the process as defined before, and preferably in combination with any of the embodiments before, volatile components are removed using steam distillation, thermal distillation, vacuum distillation, gas strip-ping, to reduce and preferably essentially remove remaining amounts of mono-er(s) M1, and reaction by-products, to a level which is a required level or an acceptable level for the intended area of application, such step being performed at ambient, reduced or over-pressure of at most 2 bar absolute pressure, to reduce the content of the organic solvent(s), residual volatile monomers such as vinyl esters, to a content of at most 1 weight percent, preferably at most 0.5, more preferably at most 0.01 percent, based on the total weight of the polymer dispersion obtained.

In preferred embodiment P5 of the process as defined before, and preferably in combination with any of the embodiments before, the dispersion finally obtained after the last process step to polymerize and—if employed—to purify is filtered to remove polymer agglomerates of sizes beyond 125 micrometer.

### Uses

Also part of this invention is the use of the aqueous polymer dispersion as detailed herein before, and/or the aqueous polymer dispersion obtainable from the process as detailed herein before, as opacifier in liquid formulations and liquid compositions. More specifically, such aqueous polymer dispersion is preferably used in in the area of cleaning compositions for use on fabric and/or hard surfaces, and for use in industrial and institutional cleaning.

Further part of this invention is a liquid or semi-liquid formulation or composition comprising at least one aqueous polymer dispersion as detailed herein before, and/or an aqueous polymer dispersion obtainable from the process as detailed herein before, for use in the area of cleaning compositions for use on fabric and/or hard surfaces, and for use in industrial and institutional cleaning. Preferably, such aqueous polymer dispersion is used therein as opacifier.

Further part of this invention is a liquid or semi-liquid detergent composition comprising at least one aqueous polymer dispersion as detailed herein before, and/or an aqueous polymer dispersion obtainable from the process as detailed herein before, such composition being preferably a laundry detergent, a hand-dish detergent, an automated dish wash detergent, or a hard-surface cleaner, more preferably for the area of home and fabric care.

Preferably, such aqueous polymer dispersion is used therein as opacifier.

Hence, a preferred subject matter of this invention is also the use of at least one aqueous polymer dispersion as detailed herein before, and/or an aqueous polymer dispersion obtainable from the process as detailed herein before in fabric care and home care products, preferably in cleaning compositions and in laundry treatment, laundry care products and laundry washing products, more preferably a laundry detergent formulation, even more preferably a liquid laundry detergent formulation. In particular, the aqueous polymer dispersion is employed in such composition/product/formulation to impart opacity.

Such inventive uses encompass the use of the at least one aqueous polymer dispersion as detailed herein before, and/or an aqueous polymer dispersion obtainable from the process as detailed herein before, such polymer dispersion resembling that as detailed above describing the polymer structure in all of its embodiments, variations, and preferred, more preferred etc. embodiments.

Another subject-matter of the present invention is, therefore, a cleaning composition, a fabric care and home care product, preferably a laundry cleaning composition, a laundry treatment product or laundry care product or laundry washing product, preferably a liquid laundry detergent formulation or liquid laundry detergent product, containing at least one aqueous polymer dispersion as detailed herein before, and/or an aqueous polymer dispersion obtainable from the process as detailed herein before, such composition or product exhibiting improved opacity.

Such inventive composition or product encompass at least one aqueous polymer dispersion as detailed herein before, and/or an aqueous polymer dispersion obtainable from the process as detailed herein before, such polymer dispersion resembling that as detailed above describing the polymer structure in all of its embodiments, variations, and preferred, more preferred etc. embodiments.

In one embodiment it is also preferred that the cleaning composition, fabric care and home care product, preferably laundry cleaning composition, a laundry treatment product or laundry care product or laundry washing product, more preferably liquid laundry detergent formulation or liquid laundry detergent product, containing at least one aqueous polymer dispersion as detailed herein before, and/or an aqueous polymer dispersion obtainable from the process as detailed herein before, such composition or product preferably exhibiting improved opacity, additionally comprises at least one enzyme, preferably selected from one or more lipases, hydrolases, amylases, proteases, cellulases, mannanases, xylanases, DNases, dispersins, pectinases, oxidoreductases, hemicellulases, phospholipases, esterases, pectinases, cutinases, lactases and peroxidases, and combinations of at least two of the foregoing types, preferably at least one protease.

At least one aqueous polymer dispersion as detailed herein before, and/or an aqueous polymer dispersion obtainable from the process as detailed herein before is present in said inventive compositions and products at a concentration of from about 0.01% to about 10%, preferably 0.02 to 5%, more preferably from about 0.05% to 3%, even more preferably from about 0.1% to about 2%, and further more preferably from about 0.15% to about 2%, and most preferably in amounts of up to 1.5%, such as up to 1%, each in weight % in relation to the total weight of such composition or product, and further including all ranges resulting from selecting any of the lower limits and any of the upper limits and all numbers in between those mentioned; such composition or product may—and preferably does—further comprise from about 1% to about 70% by weight of the composition or product of a surfactant system; said compositions and products to be used as fabric care composition.

Even more preferably, the compositions or products of the present invention as detailed herein before comprising at least one aqueous polymer dispersion as detailed herein before, and/or an aqueous polymer dispersion obtainable from the process as detailed herein before, and optionally further comprising at least one surfactant or a surfactant system in amounts from about 1% to about 70% by weight of the composition or product, are those for primary cleaning (i.e. removal of stains) within laundry applications, and may additionally comprise at least one enzyme, preferably selected from one or more lipases, hydrolases, amylases, proteases, cellulases, mannanases, xylanases, DNases, dispersins, pectinases, oxidoreductases, hemicellulases, phospholipases, esterases, pectinases, cutinases, lactases and peroxidases, and combinations of at least two of the foregoing types, preferably at least one protease.

In one preferred embodiment, the cleaning composition of the present invention is a liquid or semiliquid laundry detergent composition, preferably a liquid laundry detergent composition.

In one embodiment, the inventive aqueous polymer dispersion may be utilized in cleaning compositions or products comprising a surfactant system comprising C10-C15 alkyl benzene sulfonates (LAS) as the primary surfactant and one or more additional surfactants selected from non-ionic, cationic, amphoteric, zwitterionic or other anionic surfactants, or mixtures thereof.

In a further embodiment, the inventive aqueous polymer dispersion may be utilized in the cleaning compositions or fabric and home care product, preferably a laundry cleaning composition, a laundry care product or laundry treatment product or laundry washing product, preferably a liquid laundry detergent formulation or liquid laundry detergent product, comprising C8-C18 linear or branched alkyl ethersulfates with 1-5 ethoxy-units as the primary surfactant and one or more additional surfactants selected from non-ionic, cationic, amphoteric, zwitterionic or other anionic surfactants, or mixtures thereof.

In one embodiment of the present invention, the aqueous polymer dispersion is a component of a cleaning compositions or fabric and home care product, preferably a laundry cleaning composition, a laundry care product or laundry treatment product or laundry washing product, preferably a liquid laundry detergent formulation or liquid laundry detergent product, that each additionally comprise at least one surfactant, preferably at least one anionic surfactant.

In a further embodiment, this invention also encompasses a composition comprising an aqueous polymer dispersion as described herein before, further comprises an antimicrobial agent as disclosed hereinafter, preferably selected from the group consisting of 2-phenoxyethanol, more preferably comprising said antimicrobial agent in an amount ranging from 2 ppm to 5% by weight of the composition; even more preferably comprising 0.1 to 2% of phenoxyethanol.

In a further embodiment, this invention also encompasses a method of preserving an aqueous composition against microbial contamination or growth, such composition comprising an aqueous polymer dispersion as described herein before, such composition being preferably a detergent composition, such method comprising adding at least one antimicrobial agent selected from the disclosed antimicrobial agents as disclosed hereinafter, such antimicrobial agent preferably being 2-phenoxyethanol.

In a further embodiment, this invention also encompasses a composition, preferably a cleaning composition, more preferably a liquid laundry detergent composition or a liquid hand dish composition, even more preferably a liquid laundry detergent composition, or a liquid softener composition for use in laundry, such composition comprising an aqueous polymer dispersion as described herein before, such composition further comprising 4,4′-dichoro 2-hydroxydiphenylether in a concentration from 0.001 to 3%, preferably 0.002 to 1%, more preferably 0.01 to 0.6%, each by weight of the composition.

In a further embodiment, this invention also encompasses a method of laundering fabric or of cleaning hard surfaces, which method comprises treating a fabric or a hard surface with a cleaning composition, more preferably a liquid laundry detergent composition or a liquid hand dish composition, even more preferably a liquid laundry detergent composition, or a liquid softener composition for use in laundry, such composition comprising an aqueous polymer dispersion as described herein before, such composition further comprising 4,4′-dichoro 2-hydroxydiphenylether.

The selection of the additional surfactants and further cleaning adjuncts in these embodiments may be dependent upon the application and the desired benefit.

Preferably, the cleaning compositions of the present invention are those for the field of laundry cleaning compositions and detergents for laundry and hand dish cleaning compositions. More preferably, cleaning compositions of the present invention are liquid compositions for use within the field of laundry and hard surface cleaning, such as liquid laundry detergents and liquid dish washing cleaning compositions, such as preferably for hand dish washing and for laundry.

The cleaning compositions may have a form selected from liquid, powder, single-phase or multiphase unit dose, pouch, tablet, gel, paste, bar, or flake. Preferred cleaning compositions are liquid or semi-liquid. More preferred cleaning compositions are liquid.

Compositions and formulations for industrial and institutional cleaning include those designed for cleaning soiled material or surfaces of any kind, such as hard surface cleaners for surfaces of any kind, including tiles, carpets, PVC-surfaces, wooden surfaces, metal surfaces, lacquered surfaces.

The cleaning compositions comprise a surfactant system in an amount sufficient to provide desired cleaning properties. In some embodiments, the cleaning composition comprises, by weight of the composition, from about 1% to about 70% of a surfactant system.

In other embodiments, the liquid cleaning composition comprises, by weight of the composition, from about 2% to about 60% of the surfactant system. In further embodiments, the cleaning composition comprises, by weight of the composition, from about 5% to about 30% of the surfactant system. The surfactant system may comprise a detersive surfactant selected from anionic surfactants, nonionic surfactants, cationic surfactants, zwitterionic surfactants, amphoteric surfactants, ampholytic surfactants, and mixtures thereof. Those of ordinary skill in the art will understand that a detersive surfactant encompasses any surfactant or mixture of surfactants that provide cleaning, stain removing, or laundering benefit to soiled material.

The cleaning compositions may also contain adjunct cleaning additives. Suitable adjunct cleaning additives include builders, structurants or thickeners, clay soil removal/anti-redeposition agents, polymeric soil release agents, polymeric dispersing agents, polymeric grease cleaning agents, enzymes, enzyme stabilizing systems, bleaching compounds, bleaching agents, bleach activators, bleach catalysts, brighteners, dyes, hueing agents, dye transfer inhibiting agents, chelating agents, suds suppressors, softeners, and perfumes.

All such cleaning compositions, their ingredients, their general compositions and more specific compositions are known, as for example illustrated in the publications 800542 and 800500 as published by Protegas, Liechtenstein, and also from WO 2022/136409 and WO 2022/136408, wherein the opacifying compounds—if actually employed therein or only contemplated to be used—may be replaced partially or completely by the aqueous polymer dispersions of this present invention; if not employed, the aqueous polymer dispersions of this invention may be added in the amount given in this present invention. In those beforementioned documents, also various types of formulations for cleaning compositions are disclosed; all such composition types can be equally applied also to those cleaning compositions contemplated herein.

In each of the before application areas and their compositions and formulations the aqueous polymer dispersion of this invention is preferably employed as opacifier to impart opacity to such formulations and compositions, such as for example to impart turbidity to an otherwise clear liquid formulation or a formulation which contains undissolved or emulsified ingredients and thus to “hide” those undissolved or emulsified parts of the composition or formulation by imparting turbidity and thus making such parts less visible, or—in case of clear (and preferably also colorless or only of faint colour) formulations or compositions to increase the visibility by imparting turbidity. Turbidity may be also employed to vary the visual observation of a colour by imparting turbidity and thus creating a different perception of such colour by increasing the amount of scattered light and thus for example intensifying the colour, reducing shininess or else.

The phrase “cleaning composition” as used herein includes compositions and formulations designed for cleaning soiled material. Such compositions and formulations include those designed for cleaning soiled material or surfaces of any kind, and specifically include compositions for fabric and home care.

Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, dish washing compositions, hard surface cleaning compositions, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

Compositions for “industrial and institutional cleaning” includes such cleaning compositions being designed for use in industrial and institutional cleaning, such as those for use of cleaning soiled material or surfaces of any kind, such as hard surface cleaners for surfaces of any kind, including tiles, carpets, PVC-surfaces, wooden surfaces, metal surfaces, lacquered surfaces.

The phrase “fabric care composition” is meant to include compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein and detailed herein below when describing the compositions. Such compositions may be used as a pre-laundering treatment, a post-laundering treatment, or may be added during the rinse or wash cycle of the laundering operation, and as further detailed herein below when describing the use and application of the inventive aqueous polymer dispersions and compositions comprising such dispersions.

“Compositions for Fabric and Home Care” include cleaning compositions including but not limited to laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, dish washing compositions, hard surface cleaning compositions, unit dose formulation, delayed delivery formulation, detergent contained on or in a porous substrate or nonwoven sheet, light duty liquid detergents compositions, heavy duty liquid detergent compositions, detergent gels commonly used for laundry, bleaching compositions, laundry additives, fabric enhancer compositions, and other suitable forms that may be apparent to one skilled in the art in view of the teachings herein. Such compositions may be used as a pre-laundering treatment, a post-laundering treatment, or may be added during the rinse or wash cycle of the laundering operation, preferably during the wash cycle of the laundering or dish washing operation. More preferably, such Composition for Fabric and Home Care is a laundry cleaning composition, a laundry care product or laundry washing product, most preferably a liquid laundry detergent formulation or liquid laundry detergent product.

The cleaning compositions of the invention may be in any form, namely, in the form of a “liquid” composition including liquid-containing composition types such as paste, gel, emulsion, foam and mousse; a solid composition such as powder, granules, micro-capsules, beads, noodles, pearlised balls, agglomerates, tablets, granular compositions, sheets, pastilles, beads, fibrous articles, bars, flakes; or a mixture thereof; types delivered in single-, dual- or multi-compartment pouches or containers; single-phase or multi-phase unit dose; a spray or foam detergent; premoistened wipes (i.e., the cleaning composition in combination with a nonwoven material such as that discussed in U.S. Pat. No. 6,121,165, Mackey, et al.); dry wipes (i.e., the cleaning composition in combination with a nonwoven materials, such as that discussed in U.S. Pat. No. 5,980,931, Fowler, et al.) activated with water by a user or consumer; and other homogeneous, non-homogeneous or single-phase or multiphase cleaning product forms.

The composition can be encapsulated in a single or multi-compartment pouch. A multi-compartment pouch may have at least two, at least three, or at least four compartments. A multi-compartmented pouch may include compartments that are side-by-side and/or superposed. The composition contained in the pouch or compartments thereof may be liquid, solid (such as powders), or combinations thereof.

Non-limiting examples of “liquids”/“liquid compositions” include light duty and heavy duty liquid detergent compositions, fabric enhancers, detergent gels commonly used for laundry, bleach and laundry additives. Gases, e.g., suspended bubbles, or solids, e.g. particles, may be included within the liquids.

The liquid cleaning compositions of the present invention preferably have a viscosity of from 50 to 10000 mPa*s; liquid manual dish wash cleaning compositions (also liquid manual “dish wash compositions”) have a viscosity of preferably from 100 to 10000 mPa*s, more preferably from 200 to 5000 mPa*s and most preferably from 500 to 3000 mPa*s at 20 1/s and 20 °C; liquid laundry cleaning compositions have a viscosity of preferably from 50 to 3000 mPa*s, more preferably from 100 to 1500 mPa*s and most preferably from 200 to 1000 mPa*s at 20 1/s and 20 °C.

The liquid cleaning compositions of the present invention may have any suitable pH-value. Preferably the pH of the composition is adjusted to between 4 and 14. More preferably the composition has a pH of from 6 to 13, even more preferably from 6 to 10, most preferably from 7 to 9. The pH of the composition can be adjusted using pH modifying ingredients known in the art and is measured as a 10% product concentration in demineralized water at 25 °C. For example, NaOH may be used and the actual weight % of NaOH may be varied and trimmed up to the desired pH such as pH 8.0. In one embodiment of the present invention, a pH >7 is adjusted by using amines, preferably alkanolamines, more preferably triethanolamine.

Cleaning compositions such as fabric and home care products and formulations for industrial and institutional cleaning, more specifically such as laundry and manual dish wash detergents, are known to a person skilled in the art. Any composition etc. known to a person skilled in the art, in connection with the respective use, can be employed within the context of the present invention by including at least one inventive polymer, preferably at least one polymer in amounts suitable for expressing a certain property within such a composition, especially when such a composition is used in its area of use.

One aspect of the present invention is also the use of the inventive polymers as additives for detergent formulations, particularly for liquid detergent formulations, preferably concentrated liquid detergent formulations, or single mono doses for laundry.

The cleaning compositions of the invention may—and preferably do—contain adjunct cleaning additives (also abbreviated herein as “adjuncts”), such adjuncts being preferably in addition to a surfactant system as defined before.

Suitable adjunct cleaning additives include builders, co-builders, a surfactant system, fatty acids and/or salts thereof, structurants, thickeners and rheology modifiers, clay/soil removal/antiredeposition agents, polymeric soil release agents, dispersants such as polymeric dispersing agents, polymeric grease cleaning agents, solubilizing agents, amphiphilic copolymers (including those that are free of vinyl pyrrolidone), chelating agents, enzymes, enzyme stabilizing systems, encapsulated benefit agents such as encapsulated perfume, bleaching compounds, bleaching agents, bleach activators, bleach catalysts, catalytic materials, brighteners, malodor control agents, pigments, dyes, opacifiers, pearlescent agents, hueing agents, dye transfer inhibiting agents, fabric softeners, carriers, suds boosters, suds suppressors (antifoams), color speckles, silver care, anti-tarnish and/or anti-corrosion agents, alkalinity sources, pH adjusters, pH-buffer agents, hydrotropes, scrubbing particles, antibacterial and antimicrobial agents, preservatives, anti-oxidants, softeners, carriers, fillers, solvents, processing aids, pro-perfumes, and perfumes.

Suitable examples of such cleaning adjuncts and levels of use are found for example in WO 99/05242, U.S. Pat. Nos. 5,576,282, 6,306,812 B1 and 6,326,348 B1.

All such cleaning compositions, their ingredients including (adjunct) cleaning additives, their general compositions and more specific compositions are in principle known, as for example illustrated in the publications 800542 and 800500 as published by Protegas, Liechtenstein, and also from WO 2022/136409 and WO 2022/136408, wherein in any of those before prior art documents the opacifier within the general compositions and also each individualized specific cleaning composition disclosed in the beforementioned publications may be replaced partially or completely by the dispersion of this present invention. In those beforementioned documents, also various types of formulations for cleaning compositions are disclosed; all such composition types—the general compositions and also each individualized specific cleaning composition—can be equally applied also to those cleaning compositions contemplated herein.

Hence, the present invention also encompasses any and all of such disclosed compositions of the before-mentioned prior art-disclosures but further comprising at least one of the inventive dispersion in addition to or as a replacement for any already ins such prior art-composition contained opacifier, which can be replaced by such inventive dispersion—such replacements in principle known to a person of skill in the art—, with the content of the inventive dispersion being present in said formulations at a concentration of generally from 0.05 to 20 wt. %, preferably up to 10 wt. %, more preferably 0.1 to 5 weight %, even more preferably at a concentration of 0.5 to 2 weight %, and most preferably of up to 1 wt %.

Liquid cleaning compositions additionally may comprise besides a surfactant system and graft polymer—and preferably do comprise at least one of—rheology control/modifying agents, emollients, humectants, skin rejuvenating actives, and solvents.

Solid compositions additionally may comprise—and preferably do comprise at least one of—fillers, bleaches, bleach activators and catalytic materials.

Those of ordinary skill in the art will understand that a detersive surfactant encompasses any surfactant or mixture of surfactants that provide cleaning, stain removing, or laundering benefit to soiled material.

Hence, the cleaning compositions of the invention such as fabric and home care products, and formulations for industrial and institutional cleaning, more specifically such as laundry and manual dish wash detergents, preferably additionally comprise a surfactant system and, more preferably, also further adjuncts.

The surfactant system may be composed from one surfactant or from a combination of surfactants selected from anionic surfactants, non-ionic surfactants, cationic surfactants, zwitterionic surfactants, amphoteric surfactants, and mixtures thereof. Those of ordinary skill in the art will understand that a surfactant system for detergents encompasses any surfactant or mixture of surfactants that provide cleaning, stain removing, or laundering benefit to soiled material.

The cleaning compositions of the invention preferably comprise a surfactant system in an amount sufficient to provide desired cleaning properties. In some embodiments, the cleaning composition comprises, by weight of the composition, from about 1% to about 70% of a surfactant system. In other embodiments, the liquid cleaning composition comprises, by weight of the composition, from about 2% to about 60% of the surfactant system. In further embodiments, the cleaning composition comprises, by weight of the composition, from about 5% to about 30% of the surfactant system. The surfactant system may comprise a detersive surfactant selected from anionic surfactants, non-ionic surfactants, cationic surfactants, zwitterionic surfactants, amphoteric surfactants, and mixtures thereof.

The cleaning compositions of the invention may—in addition to all other mentioned ingredients—comprise one or more enzymes selected from those disclosed herein above, more preferably a protease and/or an amylase, wherein even more preferably the protease is a protease with at least 90% sequence identity to SEQ ID NO: 22 of EP1921147B1 and having the amino acid substitution R101E (according to BPN′ numbering) and wherein the amylase is an amylase with at least 90% sequence identity to SEQ ID NO: 54 of WO2021032881A1, such enzyme(s) preferably being present in the formulations at levels from about 0.00001% to about 5%, preferably from about 0.00001% to about 2%, more preferably from about 0.0001% to about 1%, or even more preferably from about 0.001% to about 0.5% enzyme protein by weight of the composition.

The following compositions shown below including those in the tables disclose general cleaning compositions of certain types, which correspond to typical compositions correlating with typical washing conditions as typically employed in various regions and countries of the world. The at least one inventive dispersion may be added to such formulation(s) in suitable amounts as outlined herein. When the shown composition does not comprise an inventive dispersion, such composition is a comparative composition. When it comprises an inventive dispersion, especially in the amounts that are described herein as preferred, more preferred etc ranges, such compositions are considered to fall within the scope of the present invention.

(in the following all percentages by weight; if ingredients are added as solutions or dispersions, the percentage relates to the active content, i.e. usually the solid content of the ingredient in such solution or dispersion)

Liquid laundry detergents according to the present invention are composed of:
0.05-5% of at least one aqueous polymer dispersion (% by solid content)
0.05-10% of at least one cleaning polymer
1-50% of surfactants
0.1-40% of builders, cobuilders and/or chelating agents
0.1-50% other adjuncts
water to add up 100%.

Preferred liquid laundry detergents according to the present invention are composed of:
0.15-3% of at least one aqueous polymer dispersion (% by solid content)
0.2-10% of at least one cleaning polymer
5-40% of anionic surfactants selected from C10-C15-LAS and C10-C18 alkyl ethersulfates containing 1-5 ethoxy-units
1.5-10% of nonioic surfactants selected from C10-C18-alkyl ethoxylates containing 3-10 ethoxy-units
2-20% of soluble organic builders/cobuilders selected from C10-C18 fatty acids, di- and tricarboxylic acids, hydroxy-di- and hydroxytricaboxylic acids, aminopolycarboxylates and polycarboxylic acids
0.05-5% of an enzyme system containing at least one enzyme suitable for detergent use and preferably also an enzyme stabilizing system
0.5-20% of mono- or diols selected from ethanol, isopropanol, ethylenglycol, or propylenglyclol 0.1-20% other adjuncts
water to add up to 100%.

In a preferred embodiment at least one compound according to the present invention is used in a manual dish wash detergent.

Liquid manual dish wash detergents according to the present invention are composed of:
0.05-5% of at least one inventive dispersion
1-50% of surfactants
0.1-50% of other adjuncts
water to add up 100%.

Preferred liquid manual dish wash detergents according to the present invention are composed of:
0.2-1% of at least one inventive dispersion
5-40% of anionic surfactants selected from C10-C15-LAS, C10-C18 alkyl ethersulfates containing
1-5 ethoxy-units, and C10-C18 alkylsulfate
2 10% of Cocamidopropylbetaine
0-10% of Lauramine oxide
0-2% of a non-ionic surfactant, preferably a C10-Guerbet alcohol alkoxylate
0-5% of an enzyme, preferably Amylase, and preferably also an enzyme stabilizing system
0.5-20% of mono- or diols selected from ethanol, isopropanol, ethylenglycol, or propylenglyclol
0.1-20% other adjuncts
water to add up to 100%

General formula for laundry detergent compositions
according to the invention:

| | Ranges of Ingredient in Liquid |
|---|---|
| Ingredient | frame formulations |
| Linear alkyl benzene sulphonic acid | 0 to 30% |
| Coco fatty acid | 1 to 12% |
| Fatty alcohol ether sulphate | 0 to 25% |
| NaOH or mono or triethanol amine | Up to pH 7.5 to 9.0 |
| Alcohol ethoxylate | 3 to 10% |
| 1,2-Propylene glycol | 1 to 10% |
| Ethanol | 0 to 4% |
| Sodium citrate | 0 to 8% |
| water | Up to 100% |

Liquid laundry frame formulations according to the invention:

| active | | | | | | |
|---|---|---|---|---|---|---|
| (numbers: % active) | F1 | F2 | F3 | F4 | F5 | F6 |
| alcohol ethoxylat 7EO | 5.40 | 10.80 | 12.40 | 7.30 | 1.60 | 7.60 |
| Coco fatty acid K12-18 | 2.40 | 3.10 | 3.20 | 3.20 | 3.50 | 6.40 |
| Fatty alcohol ether | 5.40 | 8.80 | 7.10 | 7.10 | 5.40 | 14.00 |
| sulphate | | | | | | |
| Linear alkyl benzene | 5.50 | 0.00 | 14.50 | 15.50 | 10.70 | 0.00 |
| sulphonic acid | | | | | | |
| 1,2 Propandiol | 6.00 | 3.50 | 8.70 | 8.70 | 1.10 | 7.80 |
| Triethanolamine | 0 | 0 | 0 | 0 | 0 | 0 |
| Monoethanolamine | 0 | 0 | 4.00 | 4.30 | 0.30 | 0 |
| NaOH | 2.20 | 1.10 | 0 | 0 | 0 | 1.00 |
| Glycerol | 0 | 0.80 | 3.00 | 2.80 | 0 | 0 |
| Ethanol | 2.00 | 0 | 0 | 0 | 0.38 | 0.39 |
| Na citrate | 3.00 | 2.80 | 3.40 | 2.10 | 7.40 | 5.40 |
| Cleaning | 0.2-4 | 0.2-4 | 0.2-4 | 0.2-4 | 0.2-4 | 0.2-4 |
| Polymer (s) (total) | | | | | | |
| Other polymers | 0-6 | 0-6 | 0-6 | 0-6 | 0-6 | 0-6 |
| Protease | 0-1 | 0-1 | 0-1 | 0-1 | 0-1 | 0-1 |
| Amylase | 0-0.5 | 0-0.5 | 0-0.5 | 0-0.5 | 0-0.5 | 0-0.5 |
| Cellulase | 0-0.3 | 0-0.3 | 0-0.3 | 0-0.3 | 0-0.3 | 0-0.3 |
| Lipase | 0-0.2 | 0-0.2 | 0-0.2 | 0-0.2 | 0-0.2 | 0-0.2 |
| Mannanase | 0-0.2 | 0-0.2 | 0-0.2 | 0-0.2 | 0-0.2 | 0-0.2 |
| Pectat Lyase | 0-0.3 | 0-0.3 | 0-0.3 | 0-0.3 | 0-0.3 | 0-0.3 |
| Inventive Aqueous | 0.15-2 | 0.15-2 | 0.15-2 | 0.15-2 | 0.15-2 | 0.15-2 |
| polymer dispersion | | | | | | |
| water | to 100 | to 100 | to 100 | to 100 | to 100 | to 100 |

Further typical liquid detergent formulations LD1, LD2 and LD3 are shown in the following three tables:

Liquid detergent 1- LD1

| Liquid Detergent Formulation | |
|---|---|
| Sodium alkylbenzene sulfonic acid (C₁₀-C₁₃) LAS | 9.5% |
| C₁₃/C₁₅-Oxoalkohol reacted with 7 moles of EO | 4.5% |
| 1,2 propyleneglycol | 6% |
| ethanol | 2% |
| potassium coconut soap | 2.4% |
| NaOH | 2.2% |
| lauryl ether sulphate (Texapon) | 5.0% |
| Sodium citrate | 3% |
| Sokalan HP 20 | 2% |
| Graft Polymer * | 2% |
| Other polymers | 1-4% |
| Aqueous polymer dispersion | 0.5% |
| Water | to 100% |

Liquid detergent 2- LD2

| Liquid Detergent Formulation | |
|---|---|
| Sodium alkylbenzene sulfonic acid (C₁₀-C₁₃) | 5.5% |
| C₁₃/C₁₅-Oxoalkohol reacted with 7 moles of EO | 5.4% |
| 1,2 propyleneglycol | 6% |
| ethanol | 2% |
| potassium coconut soap | 2.4% |
| Monoethanolamine | 2.5% |
| lauryl ether sulphate | 5.4% |
| Sodium citrate | 3% |
| Sokalan HP96 | 2% |
| Graft Polymer * | 2% |
| Other polymers | 3% |
| Aqueous polymer dispersion | 0.1% |
| Water | to 100% |

Liquid detergent 3- LD3

| Liquid Detergent Formulation | |
|---|---|
| MGDA | 5.5% |
| APG, branched C13 Glucosid | 3.5% |
| 1,2 propyleneglycol | 6% |
| ethanol | 2% |
| potassium coconut soap | 4.4% |
| NaOH | 2.2% |
| lauryl ether sulphate | 9.5% |
| Sodium citrate | 3% |
| Graft Polymer * | 2% |
| Other polymers | 1-4% |
| Aqueous polymer dispersion | 1% |
| Water | to 100% |

All previous three tables: *(poly ethylene glycol of Mn 6000 g/mol as graft base, grafted with 60 weight % vinyl acetate (based on total polymer weight; produced following general disclosure of WO2007138054A1)

Liquid manual dish wash frame formulations according to the invention:

| Ingredients | MDW.1 | MDW.2 | MDW.3 | MDW.4 | MDW.5 | MDW.6 | MDW.7 | MDW.8 |
|---|---|---|---|---|---|---|---|---|
| Linear C₁₂- | 8 | 0 | 6 | 0 | 6 | 0 | 6 | 0 |
| C₁₄-alkyl- | | | | | | | | |
| benzenesulfonic | | | | | | | | |
| acid | | | | | | | | |
| C₁₂-C₁₄-fatty | 8 | 16 | 6 | 12 | 6 | 12 | 6 | 12 |
| alcohol × 2 EO | | | | | | | | |
| sulfate | | | | | | | | |
| Cocamidopropyl | 0 | 0 | 4 | 4 | 0 | 0 | 2 | 2 |
| betaine | | | | | | | | |
| Lauramine oxide | 0 | 0 | 0 | 0 | 4 | 4 | 2 | 2 |
| 2-Propylheptanol × | 0.5 | 0.5 | 0.5 | 0.5 | 0.5 | 0.5 | 0.5 | 0.5 |
| 4 EO | | | | | | | | |
| Inventive | 0.1-1 | 0.1-1 | 0.1-1 | 0.1-1 | 0.1-1 | 0.1-1 | 0.1-1 | 0.1-1 |
| Compound (s) | | | | | | | | |
| (total) | | | | | | | | |
| Ethanol | 2 | 2 | 2 | 2 | 2 | 2 | 2 | 2 |
| Polymer (s) | 0-5 | 0-5 | 0-5 | 0-5 | 0-5 | 0-5 | 0-5 | 0-5 |
| 2-Phenoxyethanol | 1 | 1 | 1 | 1 | 1 | 1 | 1 | 1 |
| (preservative) | | | | | | | | |
| Sodium chloride | 1 | 1 | 1 | 1 | 1 | 1 | 1 | 1 |
| Demin. water | add 100 | add 100 | add 100 | add 100 | add 100 | add 100 | add 100 | add 100 |
| Sodium | add | add | add | add | add | add | add | add |
| hydroxide | pH 8 | pH 8 | pH 8 | pH 8 | pH 8 | pH 8 | pH 8 | pH 8 |

It is preferred, that within the respective laundry detergent, cleaning composition and/or fabric and home care product, the at least one aqueous polymer dispersion present at a concentration of from about 0.01% to about 10%, preferably 0.02 to 5%, more preferably from about 0.05% to 3%, even more preferably from about 0.1% to about 2%, and further more preferably from about 0.15% to about 2%, and most preferably in amounts of up to 1.5%, such as up to 1%, each in weight % in relation to the total weight of such composition or product, and further including all ranges resulting from selecting any of the lower limits and any of the upper limits and all numbers in between those mentioned

The specific embodiments as described throughout this disclosure are encompassed by the present invention as part of this invention; the various further options being disclosed in this present specification as “optional”, “preferred”, “more preferred”, “even more preferred” or “most preferred” options of a specific embodiment may be individually and independently (unless such independent selection is not possible by virtue of the nature of that feature or if such independent selection is explicitly excluded) selected and then combined within any of the other embodiments (where other such options and preferences can be also selected individually and independently), with each and any and all such possible combinations being included as part of this invention as individual embodiments.

### MOST PREFERRED EMBODIMENTS

### Embodiment 1

Aqueous polymer dispersion, obtainable by radical aqueous emulsion polymerization of a mixture comprising
a) ethylenically unsaturated monomers M, with M comprising
   (1) (M1) at least one vinyl ester, preferably comprising vinyl acetate, more preferably comprising vinyl acetate at least 50%, even more preferably at least 90%, and
   (2) (M2) at least one (meth)acrylic acid ester optionally comprising methacrylic acid as minor component, the (meth)acrylic acid in the methacrylic acid ester being bonded via an ether-function to a polyalkylene oxide-derived-block (PAO), wherein the PAO consists of 2 to 40 alkylene oxide (AO), most preferably 25 AO-units, with the PAO preferably being further linked via an ether-function to an C1 to C24, preferably at least C4, more preferably at least C6, even more preferably C8 to C24-aliphatic alkanol, most preferably a C18-aliphatic alkanol, with the AO being preferably selected from EO, PO and/or BuO, more preferably at least EO in an amount of from 50, more preferably at least 75, even more preferably at least 90 wt. % most preferably essentially only EO, based on total AO; preferably comprising methacrylic acid, more preferably with the methacrylic acid ester and the free methacrylic acid being in a ratio of from about 70 w %/30 w % to 80 w %/20 w %, mor preferably about 75 w %/25 w %;
   (3) (M3) optionally further monomers polymerizable with M1 and M2, preferably none;
b) (CGCC) 1 to 15, preferably 2 to 10, more preferably 3 to 8, most preferably 4 to 6% by weight, based on the total weight of monomers M, of a carboxyl-groups-containing compound being selected from a compound bearing in its structure at least three, more preferably at least 6, 8, 10, 15, 20, 25 . . . , carboxyl-groups of which at least 10 and at most 90 percent are being deprotonated (thus forming salts with counter-ions; the counter-ions being selected from Na, K, NH4, Mg, Ca, . . . ), selected from the group comprising citric acid, isocitric acid; ethylendiamintetraacetic acid; nitriloacetic acid; tartaric acid; oligomeric and polyacrylic acid; oligomeric and poly methacrylic acid; trimelitic acid; oligomeric aminoacids with carboxy groups such as polyaspartic acid; oligomeric and polyglutaminic acid; oligomeric and polyacetates with carboxygroups such as poly(glyoxalic)aldehyde; carboxylated oligomeric and polymeric saccharides such as oxidized starch (mixtures of amylopektines, amylose); polyglucuronates; cellulose oxidized to cellouronate; natural polycarboxylatic polysaccharide such as xylanes; pektines acid; alginic acid; carboxymethylated polysaccharides based on 1,4-polyglucanes, 1,3-polyglucanes, 1,6-polyglucanes; Poly-uronic acids based on 1,4-polyglucanes, 1,3-polyglucanes, 1,6-polyglucanes; polygalacturonic; preferably carboxylated polysaccharides, more preferably carboxylated cellulose, even more preferably carboxylated methylcellulose (carboxymethylcellulose, “CMC”); and
c) (S) at least one (non-carboxylated) sacharide and/or polysaccharide, such as glucose, starch degradation products, maltodextrin, in an amount of 2 to 50, preferably 5 to 35, more preferably 10 to 30, most preferably 15 to 25 wt % based on the total weight of monomers M,
   And
d) At least one emulsifier selected from non-ionic and anionic surfactants, with
   i) the at least one an-ionic surfactant being selected from:
      Anionic emulsifier bearing at least one anionic group, which is selected from phosphate, phosphonate, sulfate and sulfonate groups;
      the anionic emulsifier typically employed in the form of their alkali metal salts, especially of their sodium salts or in the form of their ammonium salts;
      preferably the anionic emulsifier bearing at least one sulfate or sulfonate group or at least one phosphate or phosphonate group, more preferably bearing at least one sulfonate or sulfate group, most preferably only one sulfonate or one sulfate group,
      a) With the anionic emulsifier bearing at least one sulfate or sulfonate group preferably being selected from
         the salts, especially the alkali metal and ammonium salts, of alkyl sulfates, especially of C8-C22-alkyl sulfates,
         the salts, especially the alkali metal and ammonium salts, of sulfuric monoesters of C2-C3-alkoxylated alkanols, especially of sulfuric monoesters of C2-C3-alkoxylated C8-C22-alkanols, preferably having an C2-C3-alkoxylation level (AO level) in the range from 2 to 40,
         the salts, especially the alkali metal and ammonium salts, of sulfuric monoesters of C2-C3-alkoxylated alkylphenols, especially of sulfuric monoesters of C2-C3-alkoxylated C4 C18-alkylphenols (AO level preferably 3 to 40),
         the salts, especially the alkali metal and ammonium salts, of alkylsulfonic acids, especially of C8-C22-alkylsulfonic acids,
         the salts, especially the alkali metal and ammonium salts, of dialkyl esters, especially di-C4-C18-alkyl esters of sulfosuccinic acid,
         the salts, especially the alkali metal and ammonium salts, of alkylbenzenesulfonic acids, especially of C4-C22-alkylbenzenesulfonic acids, and
         the salts, especially the alkali metal and ammonium salts, of mono- or disulfonated, alkyl-substituted diphenyl ethers, for example of bis(phenylsulfonic acid) ethers bearing a C4-C24-alkyl group on one or both aromatic rings;
      With the term “C2-C3-alkoxylated” meaning that the compounds are ethoxylated, propoxylated or co-ethoxylated/propoxylated, i.e. meaning that the respective compounds are obtained by a process which introduces a polyethylenoxide group, a polypropyleneoxide group or a poly(ethyleneoxide-co-propyleneoxide) group;
      b) With the anionic emulsifier bearing at least one phosphate or phosphonate group, preferably being selected from
         the salts, especially the alkali metal and ammonium salts, of mono- and dialkyl phosphates, especially C8-C22-alkyl phosphates,
         the salts, especially the alkali metal and ammonium salts, of phosphoric monoesters of C2-C3-alkoxylated alkanols, preferably having an alkoxylation level in the range from 2 to 40, especially in the range from 3 to 30, for example phosphoric monoesters of ethoxylated C8-C22-alkanols, preferably having an ethoxylation level (EO level) in the range from 2 to 40, phosphoric monoesters of propoxylated C8-C22-alkanols, preferably having a propoxylation level (PO level) in the range from 2 to 40, and phosphoric monoesters of ethoxylated-co-propoxylated C8-C22-alkanols, preferably having an ethoxylation level (EO level) in the range from 1 to 20 and a propoxylation level of 1 to 20,
         the salts, especially the alkali metal and ammonium salts, of phosphoric monoesters of C2-C3-alkoxylated alkylphenols, especially phosphoric monoesters of C2-C3-alkoxylated C4-C18-alkylphenols (AO level preferably 3 to 40),
         the salts, especially the alkali metal and ammonium salts, of alkylphosphonic acids, especially C8-C22-alkylphosphonic acids and
         the salts, especially the alkali metal and ammonium salts, of alkylbenzenephosphonic acids, especially C4-C22-alkylbenzenephosphonic acids;
      With the more preferred anionic emulsifiers being selected from the following groups:
         the salts, especially the alkali metal and ammonium salts, of alkyl sulfates, especially of C8-C22-alkyl sulfates,
         the salts, especially the alkali metal salts, of sulfuric monoesters of C2-C3-alkoxylated alkanols, especially of sulfuric monoesters of C2-C3-alkoxylated C8-C22-alkanols, preferably having an AO level in the range from 2 to 40,
         of sulfuric monoesters of C2-C3-alkoxylated alkylphenols, especially of sulfuric monoesters of C2-C3-alkoxylated C4-C18-alkylphenols (AO level preferably 3 to 40),
         of alkylbenzenesulfonic acids, especially of C4-C22-alkylbenzenesulfonic acids, and
         of mono- or disulfonated, alkyl-substituted diphenyl ethers, for example of bis(phenylsulfonic acid) ethers bearing a C4-C24-alkyl group on one or both aromatic rings;
   ii) The at least one non-ionic surfactant being selected from:
      nonionic emulsifiers are e.g. ar-aliphatic or aliphatic nonionic emulsifiers, selected from
      C2-C3-alkoxylated mono-, di- and trialkylphenols, with the number of repeating units of the alkylene oxide-derived moiety being preferably 3 to 50, and/or the alkyl radical being preferably C4-C10-alkyl;
      C2-C3-alkyoxlates, such as ethoxylates, propoxylates or ethoxylate-co-propoxylates, of long-chain alcohols with the number of repeating units of the alkylene oxide-derived moiety being preferably 3 to 100, and/or the alkyl radical being preferably C8-C36-alkyl, and
      polyethylene oxide/polypropylene oxide homo- and copolymers, which may comprise the alkylene oxide units copolymerized in random distribution or in the form of blocks or mixtures of homo-blocks and random-blocks,
   More preferably C2-C3-alkoxylated of long-chain alkanols, in particular to those where the alkyl radical C8 C30 having a mean alkoxylation level of 5 to 100 and, among these, particular preference to those having a linear C12-C20 alkyl radical and a mean alkoxylation level of 10 to 50, and also to C2-C3-alkoxylated monoalkylphenols;
   and
e) optionally sulfate ions, and
f) optionally sulfite ions,
wherein—preferably—the amount of M1 is from 80 to 99.99 mol %, more preferably the amount of M1 being at least 98%, and the amount of M2 is from 0.01 to 20 mole %, more preferably from 0.1, even more preferably from 0.2, even more preferably from 0.5, and most preferably from 0.7, and preferably at most 10, even more preferably at most 5, more preferably at most 2%, and most preferably the amount of M1 being about 99 weight percent and the amount of M2 being about 1 weight percent, the total amount of M1 plus M2 being 100 weight percent, and
wherein the dispersion has—after the end of the polymerization—a pH of up to 4, more preferably below 4, even mor preferably at most 3.8, even more preferably at most 3.6, and more preferably at least 2.5, even more preferably at least 3, even more preferably at least 3.2, and most preferably at least 3.4.

### Embodiment 2

Dispersion according to claim 1, wherein
(M1) the vinyl ester monomer comprises vinyl acetate with at least 50%, even more preferably at least 90% based on the total molar amount of vinyl esters, and
(M2) the least one (meth)acrylic acid ester is a (meth)acrylic acid being bonded via an ether-function to a polyalkylene oxide-derived-block (PAO), wherein the PAO consists of 20 to 30 alkylene oxide (AO), most preferably 25 AO-units, with the PAO preferably being further linked via an ether-function to an C14 to C22-aliphatic alkanol, most preferably a C16/18-aliphatic alkanol, with the AO being selected from EO and PO and/or BuO, more preferably EO and PO, with the EO in an amount of from 75, even more preferably at least 90 wt. %, most preferably essentially only EO, based on total AO; further comprising methacrylic acid, with the methacrylic acid ester and the free methacrylic acid being in a ratio of from about 70 w %/30 w % to 80 w %/20 w %, mor preferably about 75 w %/25 w %; and
(M3) being not comprised.

### Embodiment 3

Dispersion according to embodiment 2, wherein
(M1) the vinyl ester monomer comprises vinyl acetate with at least 90% based on the total molar amount of vinyl esters, preferably essentially only vinyl acetate, and
(M2) the least one (meth)acrylic acid ester is a (meth)acrylic acid being bonded via an ether-function to a polyalkylene oxide-derived-block (PAO), wherein the PAO consists of 23 to 27 alkylene oxide (AO), most preferably on average 25 AO-units, with the PAO preferably being further linked via an ether-function to essentially C16/18-aliphatic alkanol, most preferably a C16/18-aliphatic alkanol, with the AO being essentially only EO; further comprising methacrylic acid, with the methacrylic acid ester and the free methacrylic acid being in a ratio of from about 70 w %/30 w % to 80 w %/20 w %, mor preferably about 75 w %/25 w %.

### Embodiment 4

Dispersion according to embodiment 3, wherein
(M1) is vinyl acetate, and
(M2) the least one (meth)acrylic acid ester is a methacrylic acid being bonded via an ether-function to a polyethylene oxide block (PEO), wherein the PEO consists of on average 25 AO-units, with the PEO being further linked via an ether-function to a C16/18-aliphatic alkanol, further comprising methacrylic acid, with the methacrylic acid ester and the free methacrylic acid being in a ratio of about 75 w %/25 w %.

### Embodiment 5

Dispersion according to any of embodiments 1 to 4, wherein
the (CGCC) is a carboxyl-groups-containing compound being selected from carboxylated polysaccharides, more preferably carboxylated cellulose, even more preferably carboxylated methylcellulose (carboxymethylcellulose, “CMC”), preferably in amounts of 2.5 to 10 most preferably about 5 weight percent based on the total amount of monomers (M1+M2+M3).

### Embodiment 6

The dispersion of any of embodiments 1 to 5, wherein the dispersed polymer particles have a D[4,3] value as determined by static light scattering of at least 400 and up to 1000 nm.

### Embodiment 7

Dispersion according to any of embodiments 1 to 6, wherein
(S) at least one sacharide and/or polysaccharide is starch degradation product, preferably a maltodextrin, in an amount of 10 to 30, preferably 15 to 25 wt %, more preferably 17 to 23 wt %, based on the total weight of monomers M.

### Embodiment 8

Dispersion according to embodiment 7, wherein (S) is a degraded starch having a dextrose equivalent according to Lane and Eynon in the range from 2 to 40%.

### Embodiment 9

Dispersion according to embodiment 9, wherein (S) is maltodextrin, with a DE-value of from 10 to 30, preferably 12 to 16 or 25 to 30.

### Embodiment 10

The dispersion of any embodiments 1 to 8, wherein as compound S a degraded starch is employed having a number average molecular weight in the range from 300 to 2000 Dalton, as determined by osmometry, and preferably in a range of from 5 to 150, more preferably up to 70, even more preferably up to 50, and more preferably from 10, even more preferably from 15, and most preferably from 20, each in weight percent based on the total weight of monomers M1+M2+M3.

### Embodiment 11

Dispersion according to any of embodiments 1 to 10, having at least one of the following properties a) to d):
a) a transmittance of 525 nm-wavelength-light of at least 20% when measure as a 0.01 wt %. dispersion in water,
b) a pH of in between 2.5 and 9, preferably from 3, more preferably from 3.3, and more preferably up to 7, even more preferably up to 6, even more preferably up to 5, and most preferably about 3.5;
c) a density of from 1.04 bis 1.08 g/mL measured as 10 wt. %-dispersion (based on solid content), and
d) a viscosity of from 30 to 1000 mPas (Brookfield viscosity, spindle 3; measured as 10 wt. % dispersion; based on solid content; concentration of 30 wt. % actives).

### Embodiment 12

A process for producing a polymer dispersion according to any of embodiments 1 to 11, which comprises
A) polymerizing ethylenically unsaturated monomers M, with M comprising
   (1)(M1) at least one vinyl ester, preferably comprising vinyl acetate, more preferably comprising vinyl acetate at least 50%, even more preferably at least 90%, and
   (2)(M2) at least one (meth)acrylic acid ester optionally comprising methacrylic acid as minor component, the (meth)acrylic acid in the methacrylic acid ester being bonded via an ether-function to a polyalkylene oxide-derived-block (PAO), wherein the PAO consists of 2 to 40 alkylene oxide (AO), most preferably 25 AO-units, with the PAO preferably being further linked via an ether-function to an C1 to C24, preferably at least C4, more preferably at least C6, even more preferably C8 to C24-aliphatic alkanol, most preferably a C18-aliphatic alkanol, with the AO being preferably selected from EO, PO and/or BuO, more preferably at least EO in an amount of from 50, more preferably at least 75, even more preferably at least 90 wt. % most preferably essentially only EO, based on total AO; preferably comprising methacrylic acid, more preferably with the methacrylic acid ester and the free methacrylic acid being in a ratio of from about 70 w %/30 w % to 80 w %/20 w %, mor preferably about 75 w %/25 w %; and
   (3) (M3) optionally further monomers polymerizable with M1 and M2, preferably none;
in the presence of
   at least one emulsifier,
   water,
   (CGCC) 1 to 15, preferably 2 to 10, more preferably 3 to 8, most preferably 4 to 6% by weight, based on the total weight of monomers M, of a carboxyl-groups-containing compound being selected from a compound bearing in its structure at least three, more preferably at least 6, 8, 10, 15, 20, 25 . . . , carboxyl-groups of which at least 10 and at most 90 percent are being deprotonated (thus forming salts with counter-ions; the counter-ions being selected from Na, K, NH4, Mg, Ca, . . . ), selected from the group comprising citric acid, isocitric acid; ethylendiamintetraacetic acid; nitriloacetic acid; tartaric acid; oligomeric and polyacrylic acid; oligomeric and poly methacrylic acid; trimelitic acid; oligomeric aminoacids with carboxy groups such as polyaspartic acid; oligomeric and polyglutaminic acid; oligomeric and polyacetates with carboxygroups such as poly(glyoxalic)aldehyde; carboxylated oligomeric and polymeric saccharides such as oxidized starch (mixtures of amylopektines, amylose); polyglucuronates; cellulose oxidized to cellouronate; natural polycarboxylatic polysaccharide such as xylanes; pektines acid; alginic acid; carboxymethylated polysaccharides based on 1,4-polyglucanes, 1,3-polyglucanes, 1,6-polyglucanes; Poly-uronic acids based on 1,4-polyglucanes, 1,3-polyglucanes, 1,6-polyglucanes; polygalacturonic; preferably carboxylated polysaccharides, more preferably carboxylated cellulose, even more preferably carboxylated methylcellulose (carboxymethylcellulose, “CMC”); and
   (S) at least one (non-carboxylated) sacharide and/or polysaccharide, such as glucose, starch degradation products, maltodextrin, in an amount of 2 to 50, preferably 5 to 35, more preferably 10 to 30, most preferably 15 to 25 wt % based on the total weight of monomers M,
with the use of at least one radical initiator or a radical initiator couple, such couple preferably comprising a peroxide and a reducing compound;
such polymerization being performed
   in a reaction container equipped with either pressurized equipment and/or equipment to control boiling of the ingredients and with such measure(s) being able to contain the ingredients within the reaction container during the reaction at elevated temperature;
   at a temperature of from 60 to 90, preferably 70 to 80 °C;
   at a pH of up to 4, more preferably below 4, even mor preferably at most 3.8, even more preferably at most 3.6;
with
B) optionally adding further radical initiator or initiator couple to further reduce the content of the unreacted monomers and/or to reduce the colour of the to be obtained polymer dispersion;
C) optionally adding at least one further reducing compound to reduce the colour of the to be obtained polymer dispersion,
D) optionally adding at least one further additive that might be needed or desired as additional ingredient within the to be obtained polymer dispersion;
E) optionally performing a step of removing evaporatable compounds from the reaction mixture by employing a distillation step and/or a stripping step using steam or a gas, preferably steam;
F) optionally performing a step of filtrating the polymer dispersion from the previous step, preferably using a 125 micrometer filter;
to obtain the polymer dispersion.

### Embodiment 13

Process according to embodiment 12, wherein for the main polymerization step at least one persulfate as radical polymerization initiator and ascorbic acid and/or iso-ascorbic acid are employed.

### Embodiment 14

The process according to embodiment 12 or 13, wherein the radical polymerization initiator additionally comprises a transition metal.

### Embodiment 15

Process according to any of embodiments 12 to 14, wherein for the post polymerization step at least one hydroperoxide and at least one sulfite salt is used.

### Embodiment 16

Process according to embodiment 15, wherein at least 5% of the total amount of the hydroperoxide being added is added after the end of the addition of the sulfite.

### Embodiment 17

Process according to any of embodiments 12 to 16, wherein volatile components are removed using steam distillation, thermal distillation, vacuum distillation, gas stripping, to reduce and preferably essentially remove remaining amounts of monomer(s) M1, and reaction by-products, to a level which is a required level or an acceptable level for the intended area of application, such step being performed at ambient, reduced or over-pressure of at most 2 bar absolute pressure, to reduce the content of the organic solvent(s), residual volatile monomers such as vinyl esters, to a content of at most 1 weight percent, preferably at most 0.5, more preferably at most 0.01 percent, based on the total weight of the polymer dispersion obtained.

### Embodiment 18

Process according to any of embodiments 12 to 17, wherein the dispersion is filtered to remove polymer agglomerates of sizes beyond 125 micrometer.

### Embodiment 19

Use of the aqueous polymer dispersion of embodiments 1 to 11, or the aqueous polymer dispersion obtainable or obtained by any of embodiments 12 to 18, as opacifying ingredient.

### Embodiment 20

The use of embodiment 19 as opacifying ingredient in liquid and semi-liquid compositions in the area of cleaning compositions for use on fabric and hard surfaces, industrial and institutional cleaning.

### Embodiment 21

The use according to embodiment 19 or 20, wherein the composition additionally comprises at least one enzyme.

### Embodiment 22

The use according to any of embodiment 19 to 21, for imparting opacity.

### Embodiment 23

The use according to any of embodiment 19 to 22, wherein the at least one aqueous polymer dispersion is present at a concentration of from about 0.01% to about 10% in weight % (based on the solid content of the aqueous polymer dispersion) in relation to the total weight of such composition or product.

### Embodiment 24

The use according to any of embodiments 14 to 18, such product or composition further comprising from about 1% to about 70% by weight of a surfactant system, and optionally further comprising at least one antimicrobial agent.

### Embodiment 25

A liquid or semi-liquid formulation containing at least one aqueous polymer dispersion as defined in any one of embodiments 1 to 11, or the aqueous polymer dispersion obtainable or obtained by any of embodiments 12 to 18, in an amount of from 0.01 to 10% (based on solid content of the aqueous polymer dispersion) based on the total solids of such formulation.

### Embodiment 26

The formulation according to embodiment 25, being a cleaning composition for use on fabric and/or hard surfaces.

### Embodiment 27

A formulation according to any of embodiments 25 or 26 being a laundry detergent, a cleaning composition or a fabric and home care product containing at least one aqueous polymer dispersion for imparting opacity.

### Embodiment 28

A formulation according to any of embodiments 25 to 27, further comprising from about 1% to about 70% by weight of a surfactant system, and optionally comprising at least one antimicrobial agent and/or at least one enzyme.

### Embodiment 29

A formulation according to any of embodiments 25 to 28, further comprising 2-phenoxyethanol as anti-microbial agent, preferably in an amount ranging from 2 ppm to 5%, more preferably comprising 0.1 to 2%, all by weight of the composition.

### Embodiment 30

A formulation according to any of embodiments 25 to 29, further comprising 4,4′-dichloro 2-hydroxydiphenylether in a concentration from 0.001 to 3%, preferably 0.002 to 1%, more preferably 0.01 to 0.6%, each by weight of the composition.

### Embodiment 31

A method of preserving a formulation according to any of embodiments 25 to 30 against microbial contamination or growth, which method comprises addition of 2-phenoxyethanol as an antimicrobial agent to the composition which is an aqueous composition comprising water as solvent.

### Embodiment 32

A method of laundering fabric or of cleaning hard surfaces, which method comprises treating a fabric or a hard surface with a formulation according to any of embodiments 25 to 29, comprising 4,4′-dichoro 2-hydroxydiphenylether, preferably comprising 4,4′-dichloro 2-hydroxydiphenylether in a concentration from 0.001 to 3%, preferably 0.002 to 1%, more preferably 0.01 to 0.6%, each by weight of the composition.

The following examples shall further illustrate the present invention without restricting the scope of the present invention.

### Examples

NTU values: See table, determined in liquid detergent

### General Description of Examples

General Recipe

| Feed | Numbering | Amount 1) | | Ingredient 1) | Content |
|---|---|---|---|---|---|
| Pre charge | 1 | 383 | g | De-ionized Water | 100% |
| | 2 | 17.5 g-35 g | | Carboxymethylcellulose | 100% |
| | 3 | 65-85 | g | Maltodextrin | 95% |
| | 4 | 1.75 g-3.5 g | | Sodium Acetate | 100% |
| Feed 1 | 1 | 170 | g | DI-Water | 100% |
| | 2 | 7-8.5 | g | Alkyldiphenyloxide Disulfonate | 45% |
| | 3 | 12-13 | g | Fatty alcohol polyglycol ether | 28% |
| | | | | sulphate, sodium salt | |
| | 4 | 320 g-350 g | | Vinylacetate | 100% |
| | 5 | 4.2 g-6.5 g | | C18 PEG 1000 Methacrylate | 80% |
| | 6 | 10 | g | De-ionized Water | 100% |
| Feed 2 | 1 | 100 | g | Sodium Persulfate | 7% |
| Feed 3 | 1 | 88 | g | Ascorbic acid | 2% |
| Feed 4 | 1 | 10.5 | g | Tert.-Butyl hydroperoxide | 10% |
| Feed 5 | 1 | 42 | g | Sodium acetone bisulfite | 2.5% |
| Feed 6 | 1 | 4.4 | g | Hydrogen peroxide | 15% |

1) Amounts and ingredients changed for further examples according to the tables shown below (if deviating amounts are given in the tables compared to this general recipe).

### General Process Description

1. Heat precharge to 60/70 °C inner temperature with 120 upm under nitrogen
2. At temperature add 5% of Feed 1 in 1 min and wait for 5 min
3. Start Feed 2 (4 h 15 min) and Feed 3 (4 h 15 min)
4. After 15 min of Feed 2 and Feed 3 start rest of Feed 1 (3 h 30 min)
5. When Feed 2 and Feed 3 are finished add Feed 4 (1 min) and wait for 5 min
6. Start Feed 5 (1 h 30 min)
7. After Feed 5 wait for 30 min, then add Feed 6 (1 min)
8. Wait for 30 min
9. Cool down to 23 °C inner temperature
10. While filling filter the trial with a 125 μm filter

### Apparatuses

4 L cylindric glass reactor
V4A round anchor stirrer
Gravimetric dosing modules
Heating bath

### Detailed Description of General Recipe

At RT (23 °C) the reactor is charged with the Initial Charge, consisting of demineralized water, Finnfix 10 (carboxymethylcellulose) and sodium acetate as buffer. Afterwards the mixture is heated up to 70 °C with stirring under N2 atmosphere.

For feed 1 demineralized water is mixed with demineralized water, Disponil FES 27, vinyl acetate and Visiomer C 18 PEG 1105 MA W. To create an emulsion the feed is mixed with a homogenizer.

At 70 °C and 5% of feed 1 is added in 1 minute. Then the mixture is stirred for 5 minutes.

Afterwards feed 2, a 7% sodium persulfate solution and feed 3, a 2% ascorbic acid solution are added in 4 hours and 30 minutes. After 30 minutes of feed 2 and 3 the remaining 95% of feed 1 are added in 3 hours and 30 minutes.

When feed 2 and 3 are finished stir for 10 minutes. Then add feed 4, tert.-butyl hydroperoxide in one shot and feed 5, a 2.5% sodium acetone bisulfate solution in 1 hour and 30 minutes as chemical deodorization. After feed 5 cool down to room temperature. The final product is filtered with a 125 μm nylon filter.

### Table of Experiments

Examples 1-24: Monomer ingredients, amounts, analytics

| | | | | | | | | | | | Turbidity | | | | | | |
|---|---|---|---|---|---|---|---|---|---|---|---|---|---|---|---|---|---|
| | | | | | | | | | | | 0,1% in | | | | | | Biodegra- |
| | | | | | | Amount | | Amount | | | detergent | | | | | | dation |
| | | | | Amount | | (pphm) | | (pphm) | Solid | | com- | | Coag- | D | D | D | OECD |
| | Monomer | Amount | Monomer | (pphm) | Additive | Additive | Additive | Additive | content | | position | | ulate | [0.1] | [0.5] | [0.9] | 301F |
| Example | 1 | (pphm) | 2 | 2 | 1 | 1 | 2 | 2 | (%) | LD | LD2 | pH | (%) | μm | μm | μm | [%] |
| 1 | Vinyl- | 99 | Visiomer | 1 | | | Sokalan | 5 | 30.3 | 19 | 2222 | 5.1 | 0.2 | 0.541 | 1.151 | 3.059 | |
| | acetat | | C18PEG | | | | CP 5 | | | | | | | | | | |
| 2 | Vinyl- | 99 | Visiomer | 1 | | | Polygluta- | 5 | 29.4 | 26 | 1866 | 4.3 | 1.5 | 0.108 | 0.415 | 5.376 | |
| | acetat | | C18PEG | | | | mic acid | | | | | | | | | | |
| 3 | Vinyl- | 99 | Visiomer | 1 | | | Polyaspa- | 5 | 30.9 | 43 | 1475 | 4.6 | 0.1 | 0.145 | 0.311 | 0.908 | |
| | acetat | | C18PEG | | | | raginic acid | | | | | | | | | | |
| 4 | Vinyl- | 100 | | | | | Finnfix 10 | 5 | 30.6 | 21 | 2151 | 3.5 | 0.3 | 0.498 | 0.682 | 0.946 | 20 |
| | acetat | | | | | | | | | | | | | | | | |
| 5 | Vinyl- | 99 | Visiomer | 1 | | | Finnfix 10 | 5 | 30.2 | 22 | 3479 | 3.5 | 0.1 | 0.100 | 0.600 | 0.912 | |
| | acetat | | C18PEG | | | | | | | | | | | | | | |
| 6 | Vinyl- | 99 | Visiomer | 1 | | | Finnfix 10 | 5 | 29.2 | 24 | 2210 | 3.5 | 0.1 | 0.502 | 0.748 | 1.171 | |
| | acetat | | C18PEG | | | | | | | | | | | | | | |
| 7 | Vinyl- | 99 | Visiomer | 1 | C*Dry | 20 | Finnfix 10 | 5 | 34.8 | 30 | 2000 | 3.5 | 0.3 | 0.322 | 0.900 | 4.174 | 63 |
| | acetat | | C18PEG | | 01910 | | | | | | | | | | | | |
| 8 | Vinyl- | 99 | Visiomer | 1 | | | Finnfix 10 | 5 | 30.1 | 23 | 2180 | 3.7 | 0.2 | 0.484 | 0.727 | 1.203 | 71 |
| | acetat | | C18PEG | | | | | | | | | | | | | | |
| 9 | Vinyl- | 99 | Visiomer | 1 | C*Dry | 20 | Finnfix 10 | 5 | 35.4 | 28 | 2121 | 3.3 | 0.2 | 0.428 | 0.602 | 0.820 | 63 |
| | acetat | | C18PEG | | 01910 | | | | | | | | | | | | |
| 10 | Vinyl- | 99 | Plex | 1 | | | Finnfix 10 | 5 | 30.4 | 26 | 2313 | 3.7 | 0.1 | 0.442 | 0.610 | 0.833 | |
| | acetat | | 6877-O | | | | | | | | | | | | | | |
| 11 | Vinyl- | 99 | Plex | 1 | | | Finnfix 10 | 5 | 31.1 | 22 | 2223 | 3.6 | 0.1 | 0.544 | 0.757 | 1.061 | |
| | acetat | | 6856-O | | | | | | | | | | | | | | |
| 12 | Vinyl- | 99 | Visiomer | 1 | C*Dry | 20 | Finnfix 10 | 2.5 | 35.2 | 32 | 1756 | 2.5 | 0.2 | 0.616 | | | |
| | acetat | | C18PEG | | 01924 | | | | | | | | | | | | |
| 13 | Vinyl- | 99 | Sipomer | 1 | C*Dry | 20 | | | 20.5 | 58 | | 2.2 | | 0.276 | | | |
| (com- | acetat | | BEM | | 01910 | | | | | | | | | | | | |
| parative) | | | | | | | | | | | | | | | | | |
| 14 | Vinyl- | 95 | Bisomer | 5 | C*Dry | 20 | | | 40.3 | 45 | | 2.4 | n.f. | | | | |
| (com- | acetat | | S 20W | | 01910 | | | | | | | | | | | | |
| parative) | | | | | | | | | | | | | | | | | |
| 15 | Vinyl- | 99 | Visiomer | 1 | C*Pur | 20 | Finnfix 10 | 5 | 36.0 | 35 | 1632 | 3.5 | 0.1 | 0.570 | | | |
| | acetat | | C18PEG | | 01910 | | | | | | | | | | | | |
| 16 | Vinyl- | 99 | Visiomer | 1 | C*Pur | 20 | Finnfix 10 | 5 | 35.6 | 33 | 1632 | 3.5 | 0.1 | 0.581 | | | |
| | acetat | | C18PEG | | 01910 | | | | | | | | | | | | |
| 17 | Vinyl- | 99 | Visiomer | 1 | C*Pur | 20 | Finnfix 10 | 5 | 35.2 | 31 | 1448 | 3.6 | 0.1 | 0.592 | | | |
| | acetat | | C18PEG | | 01910 | | | | | | | | | | | | |
| 18 | Vinyl- | 99 | Visiomer | 1 | C*Dry | 20 | Finnfix 10 | 5 | 35.1 | 32 | 1841 | 3.4 | 0.1 | 0.594 | | | |
| | acetat | | C18PEG | | 01910 | | | | | | | | | | | | |
| 19 | Vinyl- | 99 | Metha- | 1 | C*Dry | 20 | | | 20.0 | 47 | | 2.2 | | 0.302 | | | |
| | acetat | | crylic acid | | 01910 | | | | | | | | | | | | |
| 20 | Vinyl- | 99, | Metha- | 0.25 | C*Dry | 20 | | | 20.5 | 45 | | 2.4 | | 0.272 | | | |
| | acetat | 75 | crylic acid | | 01910 | | | | | | | | | | | | |
| 21 | Vinyl- | 94 | Visiomer | 1 | Me- | 5 | Finnfix 10 | 5 | 29.7 | 39 | 1571 | 3.4 | 2.5 | 0.505 | | | |
| | acetat | | C18PEG | | thac- | | | | | | | | | | | | |
| | | | | | rylsau- | | | | | | | | | | | | |
| | | | | | re | | | | | | | | | | | | |

Reaction conditions, ingredients, amounts

| | | | | | Sodium | | | | | | |
|---|---|---|---|---|---|---|---|---|---|---|---|
| | | | | | acetate | | | | | | |
| | | | | | (= addi- | | | | | | |
| | | | Protective | | tive); | | | | | | |
| | | Amount | colloid-/ | Amount | Amount | | Amount | | Amount | | Amount |
| Examples | Emulsifier | (pphm) | Emulsifier | (pphm) | (pphm) | Redox | (pphm) | Starter | (pphm) | Redox | (pphm) |
| 1 | Disponil FES 27 | 0.5 | | | 0.5 | Lutavit C | 0.50 | t-BHP | 0.3 | ABS | 0.45 |
| 2 | Disponil FES 27 | 0.5 | | | 0.5 | Lutavit C | 0.50 | t-BHP | 0.3 | ABS | 0.45 |
| 3 | Disponil FES 27 | 0.5 | | | 0.5 | Lutavit C | 0.50 | t-BHP | 0.3 | ABS | 0.45 |
| 4 | Disponil FES 27 | 0.5 | | | 0.5 | Lutavit C | 0.50 | t-BHP | 0.3 | ABS | 0.45 |
| 5 | Disponil FES 27 | 0.5 | | | 0.5 | Lutavit C | 0.50 | t-BHP | 0.3 | ABS | 0.45 |
| 6 | Disponil FES 27 | 0.5 | | | 0.5 | Lutavit C | 0.50 | t-BHP | 0.3 | ABS | 0.45 |
| 7 | Disponil FES 27 | 0.5 | | | 0.5 | Lutavit C | 0.50 | t-BHP | 0.3 | ABS | 0.45 |
| 8 | Disponil FES 27 | 1.0 | | | 0.5 | Lutavit C | 0.50 | t-BHP | 0.3 | ABS | 0.45 |
| 9 | Disponil FES 27 | 2.0 | | | 0.5 | Lutavit C | 0.50 | t-BHP | 0.3 | ABS | 0.45 |
| 10 | Disponil FES 27 | 0.5 | | | 0.5 | Lutavit C | 0.50 | t-BHP | 0.3 | ABS | 0.45 |
| 11 | Disponil FES 27 | 0.5 | | | 0.5 | Lutavit C | 0.50 | t-BHP | 0.3 | ABS | 0.45 |
| 12 | Disponil FES 27 | 0.5 | | | 0.5 | Lutavit C | 0.50 | t-BHP | 0.3 | ABS | 0.45 |
| 13 | Texapon NSO | 0.5 | | | 0.5 | Lutavit C | 0.15 | t-BHP | 0.3 | ABS | 0.45 |
| 14 | Disponil FES 77 | 1.0 | | | 1.5 | Lutavit C | 0.50 | t-BHP | 0.3 | ABS | 0.45 |
| 15 | Disponil FES 27 | 0.5 | Dowfax 2A1 | 1.0 | 0.5 | Lutavit C | 0.50 | t-BHP | 0.3 | ABS | 0.45 |
| 16 | Disponil FES 27 | 1.0 | Dowfax 2A1 | 0.5 | 0.5 | Lutavit C | 0.50 | t-BHP | 0.3 | ABS | 0.45 |
| 17 | Disponil FES 27 | 0.5 | Dowfax 2A1 | 0.5 | 0.5 | Lutavit C | 0.50 | t-BHP | 0.3 | ABS | 0.45 |
| 18 | Disponil FES 27 | 1.0 | Dowfax 2A1 | 1.0 | 0.5 | Lutavit C | 0.50 | t-BHP | 0.3 | ABS | 0.45 |
| 19 | | | | | 0.5 | Lutavit C | 0.15 | t-BHP | 0.3 | ABS | 0.45 |
| 20 | Texapon NSO | 0.5 | | | 0.5 | Lutavit C | 0.15 | t-BHP | 0.3 | ABS | 0.45 |
| 21 | Disponil FES 27 | 0.5 | | | 0.5 | Lutavit C | 0.50 | t-BHP | 0.3 | ABS | 0.45 |

| Abbreviations/ | | |
|---|---|---|
| names used | CAS | Chemical description |
| Visiomer | 70879-51-5 | 75% methacrylic ester (25 EO) C16-C18 fatty alcohol, 25 % Mathacrylic acid; SPEGMA 1100; C18- |
| C18PEG | | Ethoxylatedmethacrylic acid″, CAS 70879-51-5; (C16-)18-fatty alcohol, etherified with polyethylene |
| (Evonik) | | glycol (25 ethylene oxide-units on average) and further esterified with methacrylic acid |
| Sipomer | 125441-87-4 | ETHOXYLATED BEHENYL METHACRYLATE; Sipomer® BEM 49-53%; contains ~25% meth- |
| BEM | | acrylic acid. |
| Bisomer | 26915-72-0 | 50% aqueous solution of Methoxy. Polyethylene glycol 2000 Methacrylate; 45 EO |
| S 20W | | |
| Plex | 70879-51-5 | C18-ethoxylated methacrylic acid; C18-Ethoxylatedmethacrylic acid“, CAS 70879-51-5; (C16-)18- |
| 6877-O | | fatty alcohol, etherified with polyethylene glycol (25 ethylene oxide-units on average) and further |
| (BASF) | | esterified with methacrylic acid |
| Sokalan | | Poly(acrylic acid-co-maleic acid), as about 40 wt. % solid content in water |
| CP 5 (BASF) | | |
| C*Dry 01910 | 9050-36-6 | Maltodextrine, DE 12-16 |
| C*Dry 01924 | 9050-36-6 | Maltodextrine, DE 25-30 |
| Finnfix 10 | 9004-32-4 | Carboxymethylcellulose, DS: 0.76 |
| Disponil FES 27 | 3088-31-1 | Alkyl ethersulfates; C12-C14 Fatty alcohol + 2 EO sulfatized |
| Texapon NSO | 3088-31-1 | Sodium laurylethersulfat-solution 27% |
| Dowfax 2A1 | 119345-04-9 | 46% in water; Benzene, 1,1’-oxybis-, tetrapropylene derivatives, sulfonate |
| Lutavit C | | Ascorbic acid |
| tBHP | | Tert. Butyl hydroperoxide |
| ABS | | Acetone bisulfite sodium |

All examples: Sodium persulfate, 2 pphm

### Determination of the Opacifying Performance:

The light transmission (LD value) was determined by a photometer at 525 nm in a 1 cm cuvette. The turbidity measurement was performed with a device from Hanna (nephelometric turbidity measurement H188703) to provide NTU values.
LD: (“Lichtdurchlsssigkeit”=light transmission): 1 cm cuvette, 0.01% water; 525 nm
Particle size: Malver; D[0.5]50% of particle
Turbidity as light scattering method: nephelometric turbidity units (NTU); Formazine scale.
pH measurement: The dispersion is poured into a 250 ml beaker and the pH electrode (combination electrode) of the Knick Portamess meter is attached at 25 °C and the pH is measured. The measurement is carried out for 15 seconds until a constant pH value is reached.
Viscosity: Brookfield SP3, 25 rpm; 30% solid content dispersion

1. An aqueous polymer dispersion, obtained by radical aqueous emulsion polymerization of a mixture comprising
a) ethylenically unsaturated monomers M, with M comprising
(1) (M1) at least one vinyl ester, and
(2) (M2) at least one (meth)acrylic acid ester optionally comprising methacrylic acid as a minor component, the (meth)acrylic acid in the methacrylic acid ester being bonded via an ether-function to a polyalkylene oxide-derived-block (PAO), wherein the PAO consists of 2 to 40 alkylene oxide (AO);
(3) (M3) optionally further monomers polymerizable with M1 and M2;
b) 1 to 15%, based on the total weight of monomers M, of a carboxyl-groups-containing compound (CGCC) being selected from being a compound bearing in its structure at least three carboxyl-groups of which at least 10 and at most 90 percent are deprotonated, selected from the group consisting of citric acid, isocitric acid, ethylendiamintetraacetic acid, nitriloacetic acid, tartaric acid, oligomeric acrylic acid, polyacrylic acid, oligomeric methacrylic acid, poly methacrylic acid, trimelitic acid, oligomeric aminoacids with carboxy groups, oligomeric acetates and polyacetates with carboxygroups, carboxylated oligomeric saccharides and polymeric saccharides, natural polycarboxylatic polysaccharides, carboxymethylated polysaccharides based on 1,4-polyglucanes, 1,3-polyglucanes, or 1,6-polyglucanes, and Poly-uronic acids based on 1,4-polyglucanes, 1,3-polyglucanes, or 1,6-polyglucanes; and
c) (S) at least one non-carboxylated saccharide and/or polysaccharide, in an amount of 2 to 50%, based on the total weight of monomers M;
d) at least one emulsifier selected from the group consisting of non-ionic and anionic surfactants;
e) optionally sulfate ions; and
f) optionally sulfite ions,
wherein the dispersion has—after the end of the polymerization—a pH of up to 4.

2. The aqueous polymer dispersion according to claim 1, wherein
(M1) the vinyl ester monomer comprises at least 50% vinyl acetate based on the total molar amount of vinyl esters, and
(M2) the at least one (meth)acrylic acid ester is a (meth)acrylic acid being bonded via an ether-function to a polyalkylene oxide-derived-block (PAO), wherein the PAO consists of 20 to 30 alkylene oxide (AO) units, further comprising methacrylic acid, with the methacrylic acid ester and the free methacrylic acid being in a ratio of from about 70 w %/30 w % to 80 w %/20 w %; and
(M3) is not included.

3. The aqueous polymer dispersion according to claim 2, wherein
(M1) the vinyl ester monomer comprises at least 90% vinyl acetate based on the total molar amount of vinyl esters, and
(M2) the at least one (meth)acrylic acid ester is a (meth)acrylic acid being bonded via an ether-function to a polyalkylene oxide-derived-block (PAO), wherein the PAO consists of 23 to 27 alkylene oxide (AO) units, further comprising methacrylic acid, with the methacrylic acid ester and the free methacrylic acid being in a ratio of from about 70 w %/30 w % to 80 w %/20 w %.

4. The aqueous polymer dispersion according to claim 3, wherein
(M1) is vinyl acetate, and
(M2) the at least one (meth)acrylic acid ester is a methacrylic acid being bonded via an ether-function to a polyethylene oxide block (PEO), wherein the PEO consists of on average 25 AO-units, with the PEO being further linked via an ether-function to a C16/18-aliphatic alkanol, further comprising methacrylic acid, with the methacrylic acid ester and the free methacrylic acid being in a ratio of about 75 w %/25 w %.

5. The aqueous polymer dispersion according to claim 1, wherein the (CGCC) is a carboxyl-groups-containing compound being selected from the group consisting of carboxylated polysaccharides, carboxylated cellulose, carboxylated methylcellulose (carboxymethylcellulose, “CMC”).

6. The aqueous polymer dispersion according to claim 1, wherein the dispersed polymer particles have a D[4,3] value as determined by static light scattering of at least 400 and up to 1000 nm.

7. The aqueous polymer dispersion according to claim 1, wherein
(S) at least one saccharide and/or polysaccharide is a starch degradation product in an amount of 10 to 30%, based on the total weight of monomers M.

8. The aqueous polymer dispersion according to claim 7, wherein (S) is a degraded starch having a dextrose equivalent according to Lane and Eynon in the range from 2 to 40%.

9. The aqueous polymer dispersion of according to claim 1, wherein compound S is a degraded starch having a number average molecular weight in the range from 300 to 2000 Dalton, as determined by osmometry.

10. A process for producing the aqueous polymer dispersion according to claim 1, comprising
A) polymerizing ethylenically unsaturated monomers M, with M comprising
(1) (M1) at least one vinyl ester, and
(2) (M2) at least one (meth)acrylic acid ester optionally comprising methacrylic acid as minor component, the (meth)acrylic acid in the methacrylic acid ester being bonded via an ether-function to a polyalkylene oxide-derived-block (PAO), wherein the PAO consists of 2 to 40 alkylene oxide (AO); and
(3) (M3) optionally further monomers polymerizable with M1 and M2;
in the presence of
at least one emulsifier,
water,
1 to 15%, based on the total weight of monomers M, of a carboxyl-groups—containing compound (CGCC) being selected from being a compound bearing in its structure at least three carboxyl-groups of which at least 10 and at most 90 percent are deprotonated—and thus forming salts with counter-ions; the counter-ions being selected from the group consisting of Na, K, NH4, Mg, Ca—selected from the group consisting of citric acid, isocitric acid, ethylendiamintetraacetic acid, nitriloacetic acid, tartaric acid, oligomeric acrylic acid, polyacrylic acid, oligomeric methacrylic acid, poly methacrylic acid, trimelitic acid, oligomeric aminoacids with carboxy groups, oligomeric acetates and polyacetates with carboxygroups, carboxylated oligomeric saccharides and polymeric saccharides, natural polycarboxylatic polysaccharides, carboxymethylated polysaccharides based on 1,4-polyglucanes, 1,3-polyglucanes, or 1,6-polyglucanes, and Poly-uronic acids based on 1,4-polyglucanes, 1,3-polyglucanes, or 1,6-polyglucanes; and
(S) at least one non-carboxylated saccharide and/or polysaccharide, in an amount of 2 to 50 wt % based on the total weight of monomers M,
with the use of at least one radical initiator or a radical initiator couple,
such polymerization being performed
in a reaction container equipped with pressurized equipment and/or equipment to control boiling of the ingredients and with such measure(s) being able to contain the ingredients within the reaction container during the reaction at elevated temperature;
at a temperature of from 60 to 90 °C;
at a pH of up to 4;
with
B) optionally adding further radical initiator or initiator couple to further reduce the content of the unreacted monomers and/or to reduce the colour of the to be obtained polymer dispersion;
C) optionally adding at least one further reducing compound to reduce the colour of the to be obtained polymer dispersion,
D) optionally adding at least one further additive that might be needed or desired as additional ingredient within the to be obtained polymer dispersion;
E) optionally performing a step of removing evaporatable compounds from the reaction mixture by employing a distillation step and/or a stripping step using steam or a gas; and
F) optionally performing a step of filtrating the polymer dispersion from the previous step;
to obtain the polymer dispersion.

11. The process according to claim 10, wherein the radical polymerization initiator additionally comprises a transition metal.

12. The process according to claim 10, wherein for the post polymerization step at least one hydroperoxide and at least one sulfite salt is used.

13. The process according to claim 12, wherein at least 5% of the total amount of the hydroperoxide being added is added after the end of the addition of the sulfite.

14. A method of using the aqueous polymer dispersion according to claim 1, the method comprising using the aqueous polymer dispersion as an opacifying ingredient in a composition or product in the area of cleaning compositions for use on fabric and hard surfaces, industrial or institutional cleaning,
wherein the at least one aqueous polymer dispersion is present at a concentration of from about 0.01% to about 10% in weight %, based on the solid content of the aqueous polymer dispersion, in relation to the total weight of such composition or product.

15. A liquid or semi-liquid formulation containing at least one aqueous polymer dispersion according to claim 1, in an amount of from 0.01 to 10% (based on solid content of the aqueous polymer dispersion) based on the total solids of such formulation, further comprising from about 1 to about 70% by weight of a surfactant system, optionally further comprising at least one enzyme and at least one antimicrobial agent.

16. A method of using the aqueous polymer dispersion obtained by the process according to claim 10, the method comprising using the aqueous polymer dispersion as an opacifying ingredient in a composition or product in the area of cleaning compositions for use on fabric and hard surfaces, industrial or institutional cleaning,
wherein the at least one aqueous polymer dispersion is present at a concentration of from about 0.01% to about 10% in weight %, based on the solid content of the aqueous polymer dispersion, in relation to the total weight of such composition or product.

17. A liquid or semi-liquid formulation containing the aqueous polymer dispersion obtained by the process of claim 10, in an amount of from 0.01 to 10% (based on solid content of the aqueous polymer dispersion) based on the total solids of such formulation, further comprising from about 1 to about 70% by weight of a surfactant system, optionally further comprising at least one enzyme and at least one antimicrobial agent.

18. The aqueous polymer dispersion according to claim 1, wherein the CGCC is selected from the group consisting of polygalacturonic polysaccharides.

19. The aqueous polymer dispersion according to claim 1, wherein the CGCC is selected from the group consisting of carboxylated cellulose.

20. The aqueous polymer dispersion according to claim 1, wherein the CGCC is selected from the group consisting of carboxylated methylcellulose.
